(19) United States
(12) Patent Application Publication
(10) Pub. No.: US 2024/0055788 A1
(43) Pub. Date: Feb. 15, 2024

(54) CONNECTOR HAVING CONTACT ARRAY

(71) Applicant: Apple Inc., Cupertino, CA (US)

(72) Inventors: George Tziviskos, San Jose (S); Mohammed Nasser Khamis Al Jashmi, San Jose, CA (US); Mahmoud R. Amini, Redwood City, CA (US); Aaron N. Miletich, San Jose, CA (US); Eric S. Jol, San Jose, CA (US)

(73) Assignee: Apple Inc., Cupertino, CA (US)

(21) Appl. No.: 18/382,958

(22) Filed: Oct. 23, 2023

Related U.S. Application Data
(63) Continuation-in-part of application No. 16/885,122, filed on May 27, 2020, now Pat. No. 11,799,225.
(60) Provisional application No. 62/907,063, filed on Sep. 27, 2019.

(51) Int. Cl. H01R 12/79; H01R 13/502

(52) U.S. Cl. CPC H01R 12/79; H01R 13/502

(57) ABSTRACT

Connectors that provide a large number of connections between a flexible circuit board and a printed circuit board, can easily and securely connect the flexible circuit board to the printed circuit board, are readily manufactured, and can be used in an assembly of an electronic device without excessive warpage.

### CROSS-REFERENCES TO RELATED APPLICATIONS

This application is a continuation-in-part of U.S. patent application Ser. No. 16/885,122, filed May 27, 2020, which claims the benefit of United States provisional application Ser. No. 62/907,063, filed Sep. 27, 2019, which are incorporated by reference.

### BACKGROUND

Electronic devices are continuously becoming more complicated and are packing an ever increasing amount of functionality. To support this increasing amount of functionality, electronic devices can include a number of various types of boards, such as flexible circuit boards, printed circuit boards, and other types of boards. These boards can require a correspondingly increasing number of interconnect paths between and among them. Accordingly, it can be desirable to provide connectors that provide a large number of connections between two boards, such as a printed circuit board and a flexible circuit board.

During assembly of the electronic device, conventional connectors can be mated to both a flexible circuit board and a printed circuit board. But a complicated assembly procedure can result in component damage and the need to rework or scrap portions of the electronic device. To avoid this damage, it can be desirable that connectors readily connect the flexible circuit board to the printed circuit board. It can also be desirable that these boards can be easily disconnected in the event rework is still necessary.

These electronic devices can be portable and moved during their lifetime. As a result, they can be dropped or otherwise exposed to sudden, physically jarring events. When severe enough, these events can cause inadvertent disconnections between a flexible circuit board and a printed circuit board. It can therefore be desirable that these connectors securely connect the flexible circuit board to the printed circuit board, such that a connection can be maintained during the lifetime of the electronic device, despite the occurrence of such events.

Such electronic devices can be manufactured in large numbers. It can therefore be desirable that these connectors be readily manufactured such that constraints on electronic device assembly are avoided. Also, during electronic device assembly, these connectors can be exposed to heat. It can therefore be desirable that these connectors do not warp during device assembly.

Thus, what is needed are connectors that provide a large number of connections between a flexible circuit board and a printed circuit board, can easily and securely connect the flexible circuit board to the printed circuit board, are readily manufactured, and can be exposed to heat during assembly of an electronic device without excessive warpage.

### SUMMARY

Accordingly, embodiments of the present invention can provide connectors that provide a large number of connections between a flexible circuit board and a printed circuit board, can easily and securely connect the flexible circuit board to the printed circuit board, are readily manufactured, and can be exposed to head during assembly of an electronic device without excessive warpage.

An illustrative embodiment of the present invention can provide connectors that provide a large number of connections between a flexible circuit board and a printed circuit board. For example, the connector can include an array of contacts. The contacts in the array of contacts can each include a contacting portion to physically and electrically connect to a contact on the flexible circuit board and a surface-mount contacting portion to be soldered to a corresponding contact on the printed circuit board. Rows in a contact array can be formed by insert or injection molding an array crossbar around portions of a number of contacts. A frame having a number of slats can be insert or injection molded around several array crossbars, where the slats can fit in notches in the array crossbars. Each array crossbar can form a row of contacts and the several array crossbars can form an array. A shell can be placed over the frame, and tabs on the shell can be folded or bent under the shell to form the connector.

These and other embodiments of the present invention can provide a connector that is readily mated to a flexible circuit board and a printed circuit board. Surface-mount contact portions of contacts and shell tabs on a bottom of the connector can be highly planarized to facilitate mating to the printed circuit board. The surface-mount contacting portions can be accurately aligned during molding of array crossbars and frames such that they are highly planarized. Alternatively, the contacts can have surface-mount contacting portions that can be bent to be against a bottom surface of the frame such that they are highly planarized. The shell can include a number of tabs that can be folded under the frame. Recesses can be used to reduce a height that the shell tabs would otherwise contribute, thereby planarizing the shell tabs with the surface-mount contacting portions of the contacts. The height of the connector can be well-controlled since the height is dictated by the position of the shell tabs and a top of the shell. This can provide a connector that can reliably accept a flexible circuit board without damaging it and can accept the flexible circuit board with a consistent and reliable insertion force.

These and other embodiments of the present invention can provide a connector that securely connects a flexible circuit board to a printed circuit board. The flexible circuit board can include a cowling or stiffener. The stiffener can be fixed to a top surface of the flexible circuit board using an adhesive. The stiffener can include one or more fingers or latches that can be bent above the plane of the stiffener. During insertion, the one or more latches can be pushed flat with the stiffener. The latches can return to their original position when they reach an opening in the shell, thereby locking the stiffener and flexible circuit board to the connector. A shell crossbar can be used to limit a height of the latch in the shell opening. The flexible circuit board can be removed for rework by pushing the latch against the stiffener and extracting the flexible circuit board from the connector.

These and other embodiments of the present invention can provide a connector having a top frame attached to a bottom frame. A number of contacts can each be secured between the top frame and the bottom frame. Top contacting portions of the contacts can be exposed at a top of the top frame and bottom contacting portions of the contacts can be exposed at a bottom of the bottom frame. Ends of each of the contacts can be secured between a corresponding bottom ledge in the bottom frame and a corresponding top ledge in the top frame. A shell can be placed over the top frame. A tab on the shell can be bent around the top frame and fit into a notch in the bottom frame. A flexible circuit board plug can be inserted into the connector between the top of the top frame, a first side rail on a first side of a top of the top frame, a second side rail on a second side of the top of the top frame, and a bottom side of the shell. The contacts can be compliant or flexible to help to ensure good connections between the flexible circuit board plug and a board supporting the connector. The flexible circuit board plug can include a stiffener and a flexible circuit board, the stiffener over a portion of a top of the flexible circuit board. The stiffener can be attached to the top of the flexible circuit board using an adhesive.

The structures in these and other embodiments of the present invention can be formed of various materials. For example, the array crossbars and other portions of the frames can be formed of Liquid Crystal Polymer (LCP), such as SumikaSuper™ E6808, manufactured by Sumitomo Chemical Advanced Technologies of Phoenix, AZ, Laperos® HA475, manufactured by Polyplastics Co. of Tokyo, Japan, or Vectra® S475, manufactured by Celanese Corp. of Irving, TX. The array crossbars and other portions of frames can be formed of plastic, nylon, or other nonconductive material. The contacts can be formed of copper, copper alloy, stainless steel, or other conductive material. The stiffeners can be formed of copper, copper alloy, stainless steel, or other conductive or nonconductive material. The shells can be formed of copper, copper alloy, stainless steel, or other conductive or nonconductive material. These various structures can be formed using injection molding, stamping, 3-D printing, forging, drawing, or other manufacturing technique.

Embodiments of the present invention can provide connector systems and connectors that can be located in various types of devices, such as portable computing devices, tablet computers, desktop computers, laptops, all-in-one computers, wearable computing devices, cell phones, smart phones, media phones, storage devices, keyboards, covers, charging cases, portable media players, navigation systems, monitors, power supplies, adapters, audio devices and equipment, remote control devices, chargers, and other devices.

These connector systems and connectors can provide pathways for signals and power compliant with various standards such as one of the Universal Serial Bus (USB) standards including USB Type-C, High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In one example, the connector systems and connectors can be used to convey a data signal, a power supply, and ground. In various embodiments of the present invention, the data signal can be unidirectional or bidirectional and the power supply can be unidirectional or bidirectional. In these and other embodiments of the present invention, the connector systems and connectors can be used to convey power and ground, while data is transmitted wirelessly.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates a connector system according to an embodiment of the present invention;

FIG. 2 illustrates a front oblique view of a connector according to an embodiment of the present invention;

FIG. 3 illustrates a front view of a connector according to an embodiment of the present invention;

FIG. 4 illustrates a portion of a flexible circuit board according to an embodiment of the present invention;

FIG. 5 illustrates a side view of a flexible circuit board according to an embodiment of the present invention;

FIG. 6 illustrates a side view of a flexible circuit board mated with a connector according to an embodiment of the present invention;

FIG. 7 through FIG. 10 illustrate a method of manufacturing a connector according to an embodiment of the present invention;

FIG. 11 illustrates an underside of a connector according to an embodiment of the present invention;

FIG. 12 illustrates a side view of a portion of a connector according to an embodiment of the present invention;

FIG. 13 illustrates another connector system including a connector having a contact array mated with a corresponding flexible circuit board according to an embodiment of the present invention;

FIG. 14 illustrates a front oblique view of a connector according to an embodiment of the present invention;

FIG. 15 illustrates a portion of a flexible circuit board according to an embodiment of the present invention;

FIG. 16 illustrates a stiffener for a portion of a flexible circuit board according to an embodiment of the present invention;

FIG. 17 illustrates a portion of a flexible circuit board and stiffener according to an embodiment of the present invention;

FIG. 18 illustrates a side view of a flexible circuit board mated with a connector according to an embodiment of the present invention;

FIG. 19 through FIG. 23 illustrate a method of manufacturing a connector according to an embodiment of the present invention;

FIG. 24 is a detail view of a portion of a frame and contacts for a connector according to an embodiment of the present invention;

FIG. 25 illustrates a shell for a connector according to an embodiment of the present invention;

FIG. 26 through FIG. 28 illustrate another method of manufacturing a connector according to an embodiment of the present invention;

FIG. 29 through FIG. 32 illustrates a method of manufacturing a connector according to an embodiment of the present invention;

FIG. 33 illustrates a cutaway side view of a connector according to an embodiment of the present invention;

FIG. 34 illustrates an underside view of a connector according to an embodiment of the present invention;

FIG. 35 illustrates a close-up view of a portion of a connector according to an embodiment of the present invention;

FIG. 36 illustrates a cross-section portion of an array crossbar and a frame according to an embodiment of the present invention;

FIG. 37 illustrates an array crossbar according to an embodiment of the present invention;

FIG. 38 illustrates a cross-section of an array crossbar and frame according to an embodiment of the present invention;

FIG. 39 illustrates an array crossbar according to an embodiment of the present invention;

FIG. 40 illustrates a cross-section of a slat in a frame according to an embodiment of the present invention;

FIG. 41 illustrates a cross-section of a slat in a frame according to an embodiment of the present invention;

FIG. 42 is a pinout for a contact array of a connector according to an embodiment of the present invention;

FIG. 43 is another pinout for a contact array of a connector according to an embodiment of the present invention;

FIG. 44 illustrates a portion of a connector according to an embodiment of the present invention;

FIG. 45 illustrates a portion of the connector of FIG. 44;

FIG. 46 illustrates a portion of a flexible circuit board according to an embodiment of the present invention;

FIG. 47A and FIG. 47B illustrate a contact that can be used in a connector according to an embodiment of the present invention;

FIG. 48A and FIG. 48B illustrate a contact that can be used in a connector according to an embodiment of the present invention;

FIG. 49A and FIG. 49B illustrate a contact that can be used in a connector according to an embodiment of the present invention;

FIG. 50A and FIG. 50B illustrate a contact that can be used in a connector according to an embodiment of the present invention; and

FIG. 51A and FIG. 51B illustrate a contact that can be used in a connector according to an embodiment of the present invention.

### DESCRIPTION OF EXEMPLARY EMBODIMENTS

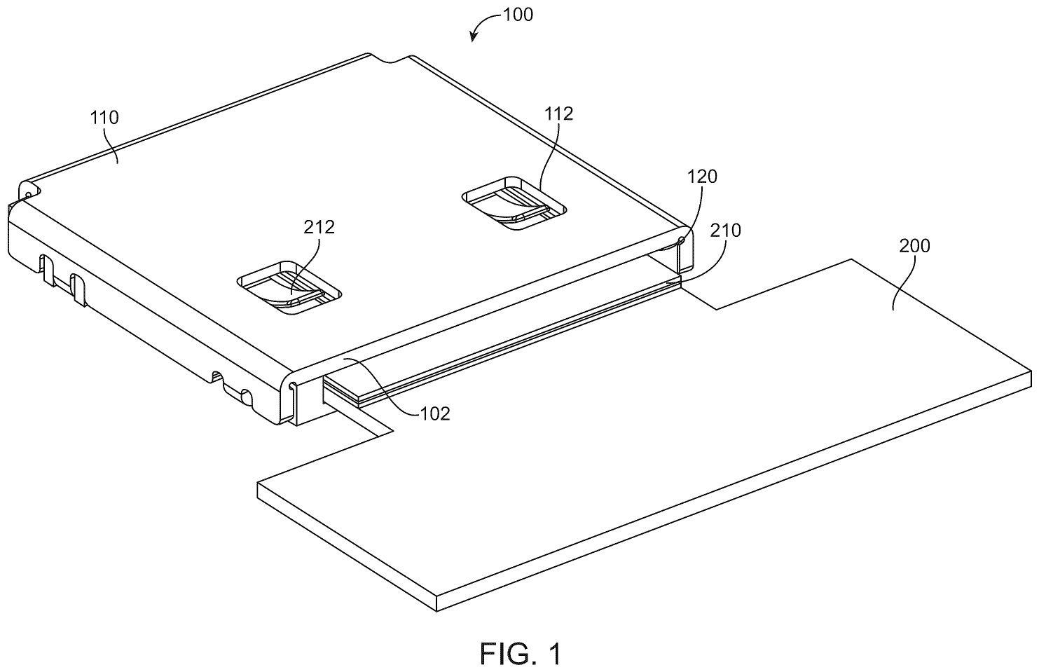

FIG. 1 illustrates a connector system according to an embodiment of the present invention. In this example, connector 100 can include shell 110 around frame 120. Opening 102 can accept a portion of flexible circuit board 200. Flexible circuit board 200 can include cowling or stiffener 210. Stiffener 210 can include latches 212 that can fit in openings 112 in shell 110. A front edge of flexible circuit board 200 and stiffener 210 can be inserted into opening 102 of connector 100 and latches 212 can fit in openings 112 in shell 110. This can help to align and secure flexible circuit board 200 in position in connector 100.

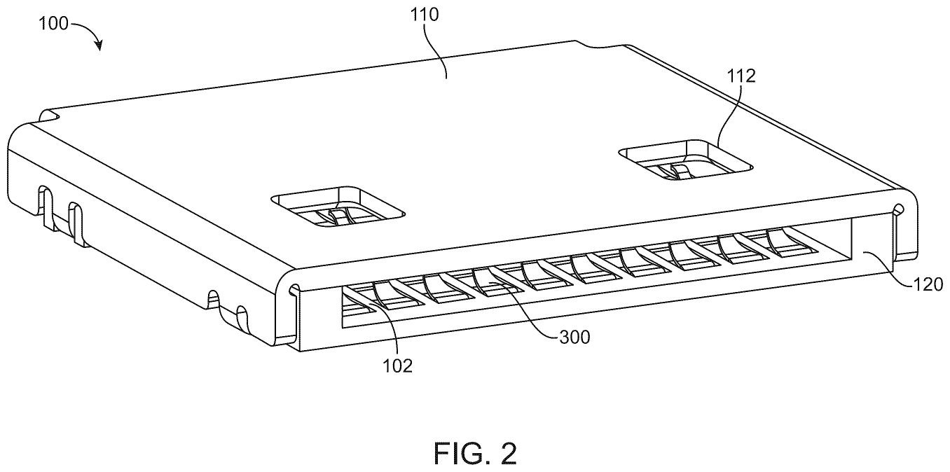

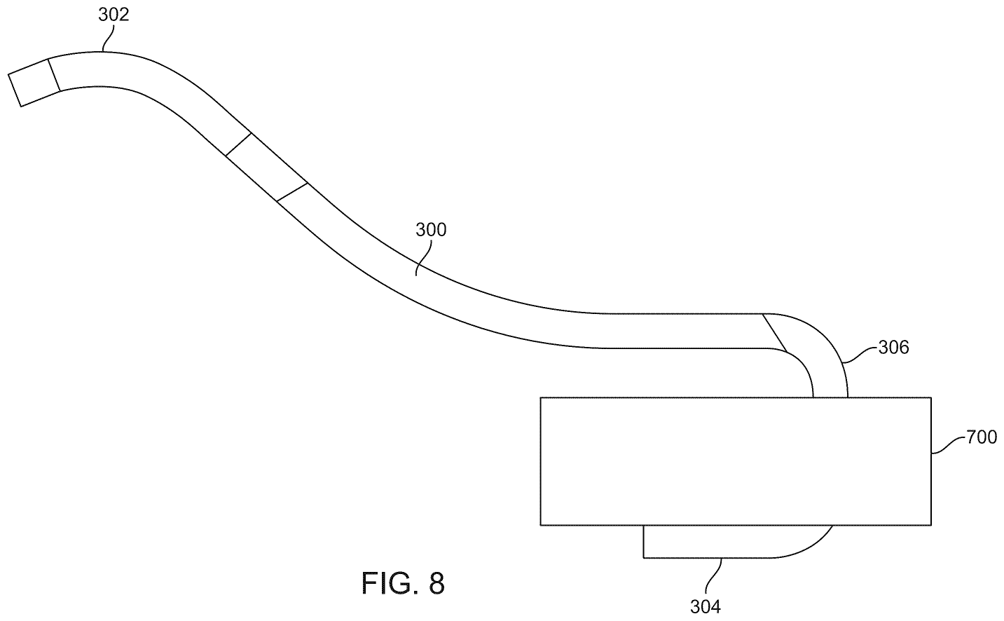

FIG. 2 illustrates a front oblique view of a connector according to an embodiment of the present invention. Connector 100 can include frame 120 protected by shell 110. Frame 120 can support an array of contacts 300, which can be accessible to flexible circuit board 200 (shown in FIG. 1) through opening 102. That is, contacts (not shown) on flexible circuit board 200 can physically and electrically connect to contacting portions 302 (shown in FIG. 8) of contacts 300. Shell 110 can include openings 112, which can accept latches 212 on stiffener 210 on flexible circuit board 200 (all shown in FIG. 1.)

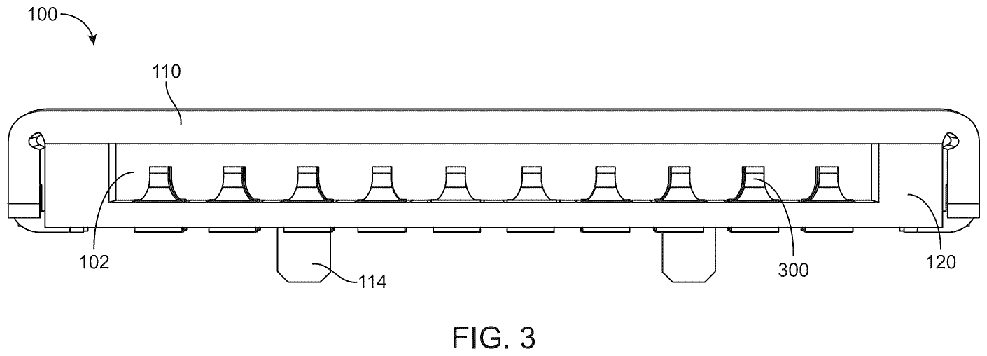

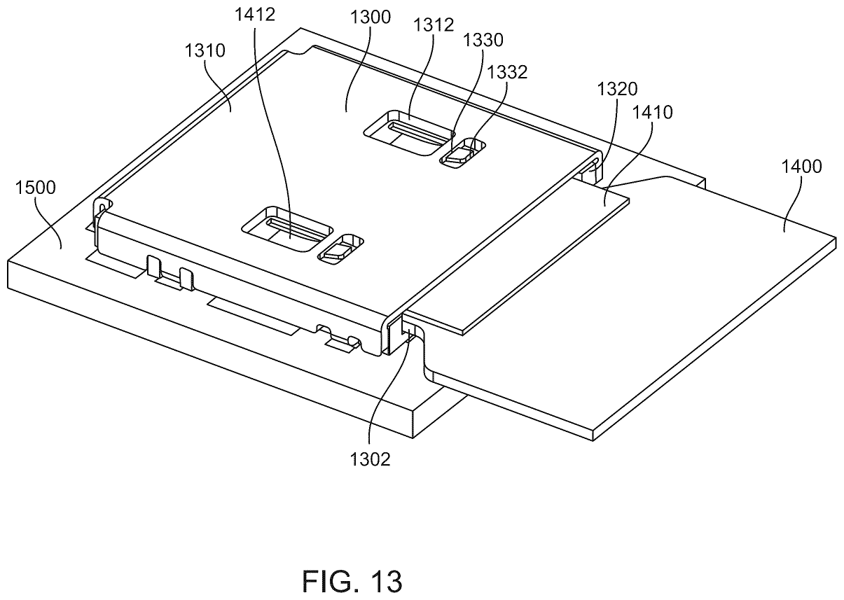

FIG. 3 illustrates a front view of a connector according to an embodiment of the present invention. In connector 100, frame 120 can be shielded by shell 110. Shell 110 can include tabs 114. Tabs 114 can be inserted into a corresponding opening (not shown) in printed circuit board 1500 (shown in FIG. 13) or other appropriate substrate. Tabs 114 can be soldered to openings in printed circuit board 1500 to form an electrical connection to ground or other potential. Frame 120 can include opening 102, into which flexible circuit board 200 (shown in FIG. 1) can be inserted to mate with contacts 300 in connector 100.

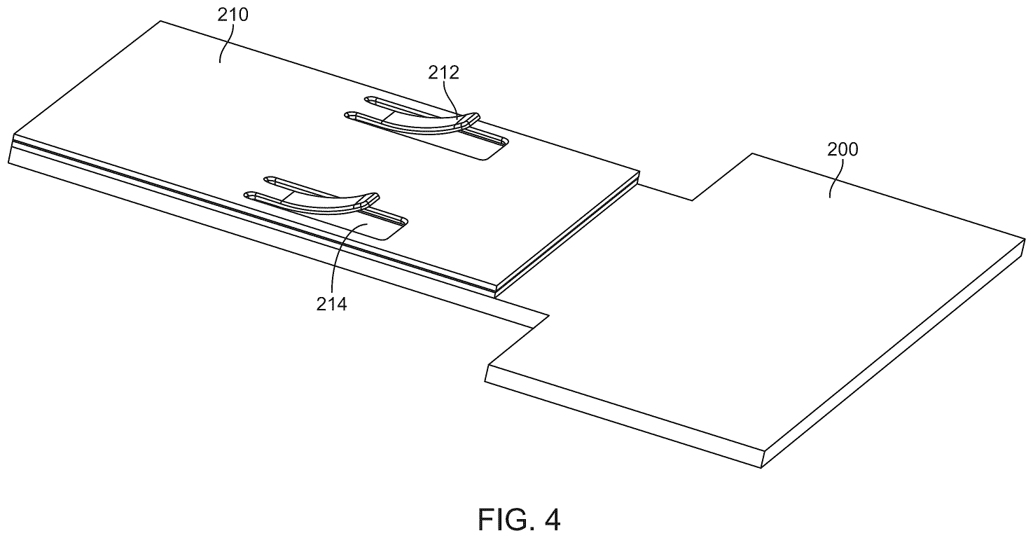

FIG. 4 illustrates a portion of a flexible circuit board according to an embodiment of the present invention. In this example, stiffener 210 can be attached to flexible circuit board 200. Stiffener 210 can be attached using adhesive or other material (not shown). For example, stiffener 210 can be attached to flexible circuit board 200 using a conductive or nonconductive adhesive, such as a conductive pressure-sensitive adhesive, a conductive temperature-sensitive or heat-activated adhesive, or other adhesive layer. Openings 214 can be formed in stiffener 210 and latches 212 can be formed by lifting or bending.

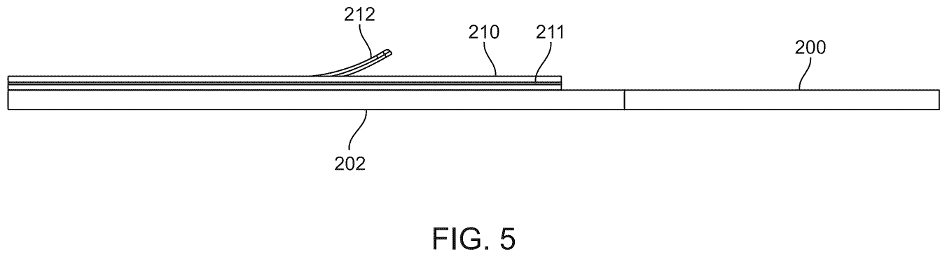

FIG. 5 illustrates a side view of a flexible circuit board according to an embodiment of the present invention. Stiffener 210 can be attached using a layer 211 of an adhesive to flexible circuit board 200. Latches 212 can be formed in stiffener 210. Contacts (not shown) can be formed on a bottom surface 202 of flexible circuit board 200. Contacts on bottom surface 202 can form electrical connections with contacting portions 302 (shown in FIG. 8) of contacts 300 in connector 100 (shown in FIG. 3.) Contacts on bottom surface 202 can be connected through traces (not shown) in and on flexible circuit board 200 to circuits, contacts, and other electrical components in an electronic device housing connector 100.

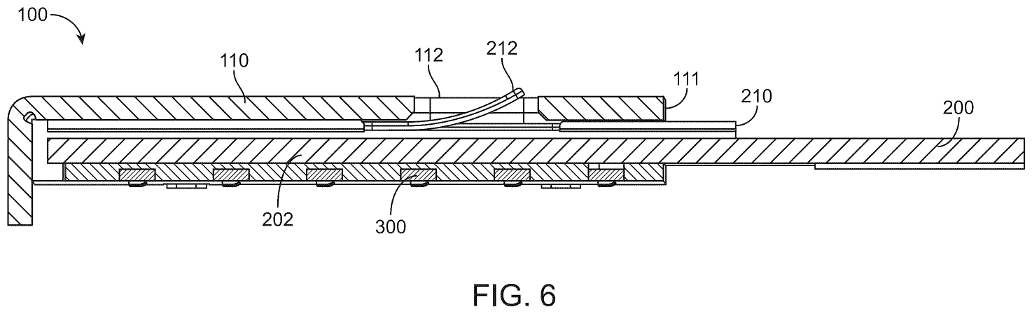

FIG. 6 illustrates a side view of a flexible circuit board mated with a connector according to an embodiment of the present invention. In this example, flexible circuit board 200 can be mated with connector 100. During insertion of flexible circuit board 200 into connector 100, latch 212 of stiffener 210 can encounter front edge 111 of shell 110 of connector 100. Front edge 111 can push latch 212 downward as shown. When latch 212 reaches opening 112 in shell 110, latch 212 can move upward to its original position. Latch 212 in opening 112 in shell 110 can help to secure flexible circuit board 200 in place in connector 100. Once in place, contacts (not shown) on bottom surface 202 flexible circuit board 200 can form electrical connections with contacts 300 of connector 100. Flexible circuit board 200 can be removed for rework by pushing latch 212 against the stiffener 210 and extracting flexible circuit board 200 from the connector 100. In these and other embodiments of the present invention, stiffener 210 can be formed of multiple layers (not shown.) One or more of these layers can be removed from a top surface of latch 212 to improve the flexibility of latch 212 and to lower the profile of latch 212 in opening 112.

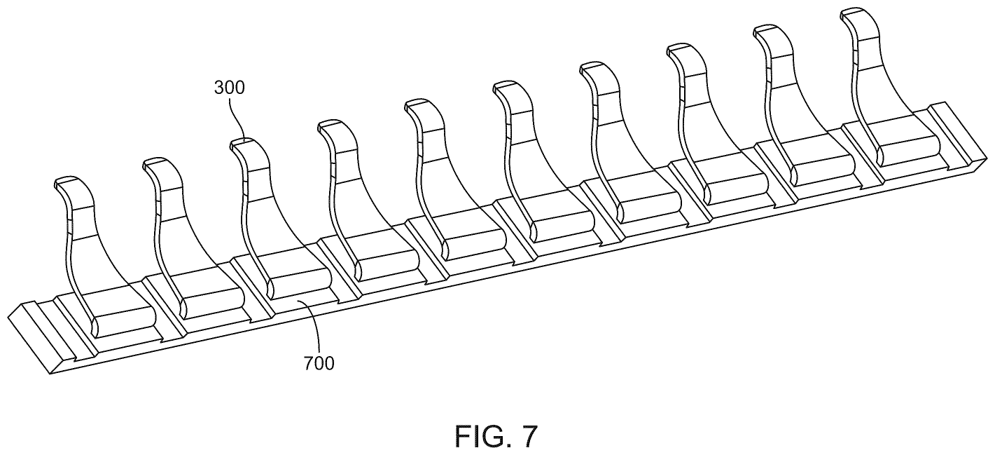

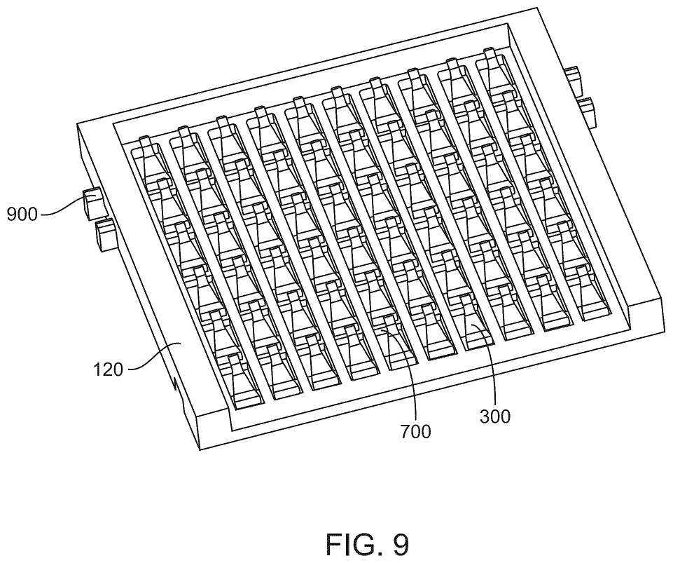

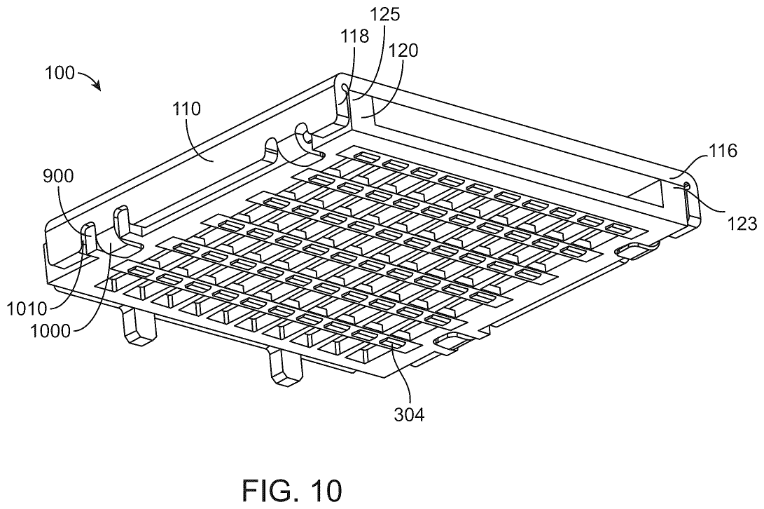

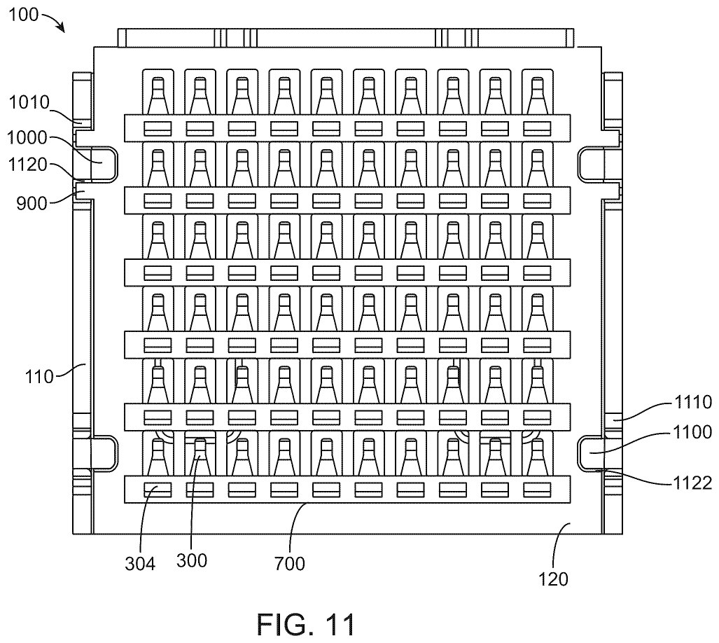

FIG. 7 through FIG. 10 illustrate a method of manufacturing a connector according to an embodiment of the present invention. In FIG. 7, a number of contacts 300 can be formed. Contacts 300 can be held in place relative to each other by array crossbar 700, which can be formed by insert or injection molding or other manufacturing process around a portion of each contact 300. Array crossbar 700 can include notches 702. In FIG. 8, contacts 300 can be supported by array crossbar 700. Each contact 300 can include a contacting portion 302 for mating with a corresponding contact on a bottom surface 202 of flexible circuit board 200, as shown in FIG. 6. Contacts 300 can also include a surface-mount contacting portions 304 at an opposite end, though contacts 300 can instead have through-hole contacting portions (not shown.) Surface-mount contacting portions 304 can be soldered to a corresponding contact (not shown) on a printed circuit board 1500 (shown in FIG. 13) or other appropriate substrate. Contacts 300 can be supported by array crossbar 700 at a middle portion 306. In FIG. 9, array crossbars 700 can be joined to frame 120 to form an array of contacts 300. Slats 122 of frame 120 can fit in notches 702 (shown in FIG. 7) of array crossbars 700 to form interlocking features to increase a rigidity and reduce warpage of frame 120 during reflow and device assembly. Frame 120 can further include tabs or protrusions 900 for aligning to shell 110, as shown in FIG. 10. In FIG. 10, shell 110 can be assembled to frame 120. Shell 110 can include tab 1000. Tab 1000 can fit between protrusions 900 to be aligned to frame 120. Protrusions 900 can fit in openings 1010 in shell 110. Tab 1000 can be bent around an underside of frame 120. A corresponding recess 1120 (shown in FIG. 11) in frame 120 can be formed to accept tab 1000 such that tab 1000 does not lift connector 100 off printed circuit board 1500 (shown in FIG. 13) or other appropriate substrate. Tabs 1000 can be soldered to a corresponding contact on the printed circuit board. Tabs 1000 and surface-mount contacting portions 304 can be planarized for mating with the printed circuit board.

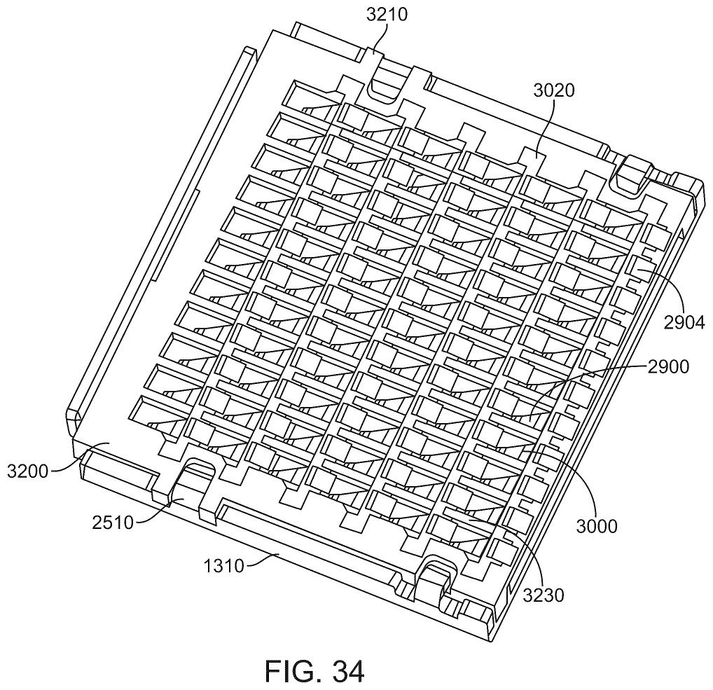

Surface-mount contacting portions 304 of contacts 300 (shown in FIG. 8) can be soldered to corresponding contacts on printed circuit board 1500 (shown in FIG. 13.) This soldering can take place during a reflow or other type of manufacturing process. This manufacturing process can cause shell 110 and frame 120 to be heated. During heating, these two structures can expand or otherwise change shape in different ways relative to each other. To compensate for these effects, during assembly, a top 123 of frame 120 can be placed directly against a top 116 of shell 110. This can allow a height of connector 100 to be maintained during the reflow process. Conversely, during assembly, a side 125 of frame 120 can be spaced away from a side 118 of shell 110. The resulting gap can allow for expansion of frame 120 during reflow. These techniques can also be applied to other embodiments of the present invention, such as connector 1300 (shown in FIG. 13), the connector shown in FIG. 34, and the other connectors described herein or otherwise provided by embodiments of the present invention.

A height of connector 100 (shown in FIG. 1), as well as the various versions of connector 1300 shown below, and the other connectors described herein and consistent with embodiments of the present invention, can be well-controlled. For example, the height of connector 100 can be dictated by the position of tabs 1000 and a top of shell 310. This well controlled height can provide a reliable connection between contacts 300 in connector 100 and contacts (not shown) on flexible circuit board 200 (shown in FIG. 1.) This height control can provide a connector 100 that can reliably accept flexible circuit board 200 without damaging flexible circuit board 200 and with a consistent and reliable insertion force.

FIG. 11 illustrates an underside of a connector according to an embodiment of the present invention. In this example, array crossbars 700 have been joined together by frame 120 to form an array of contacts 300 having surface-mount contacting portions 304 in connector 100. Shell 110 can be fit around frame 120. Frame 120 can include protrusions 900, which can fit in openings 1010 of shell 110. Tabs 1000 can be bent and fit in between protrusions 900. Frame 120 can include recess 1120 for tab 1000. The tolerances between protrusions 900 and openings 1010 can be tight. This can help to keep shell 110 and frame 120 aligned during the reflow process. Tab 1100 can be similarly bent to fit in recess 1122 in the bottom side of frame 120. In this example, corresponding protrusions from frame 120 might not be used in openings 1110. This can help to prevent warping of frame 120 during reflow. This arrangement is shown further in the following figure.

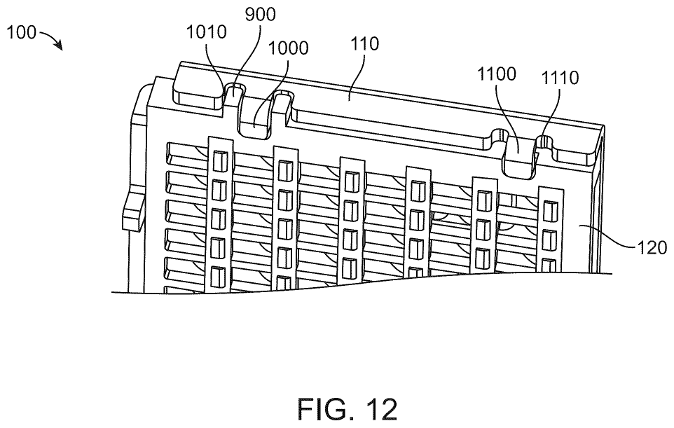

FIG. 12 illustrates a side view of a portion of a connector according to an embodiment of the present invention. Shell 110 of connector 100 can include tabs 1000 and 1100. Protrusions 900 of frame 120 can fit in openings 1010 of shell 110. Again, the tolerances between protrusions 900 and opening 1010 can be tight to control a position frame 120 relative to shell 110 during reflow. Conversely, frame 120 might not include similar protrusions for openings 1110 on each side of tab 1100. This can allow frame 120 to expand relative to shell 110 without causing frame 120 to warp during reflow.

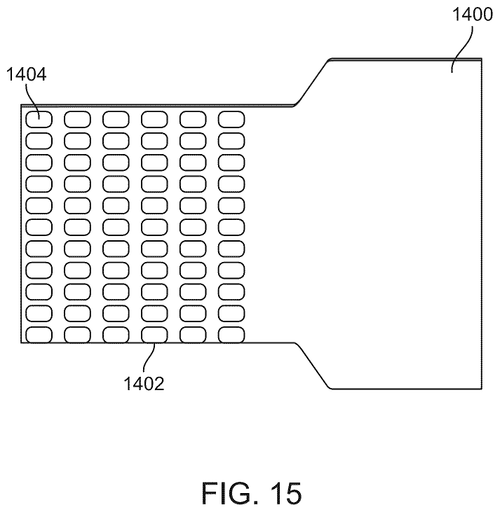

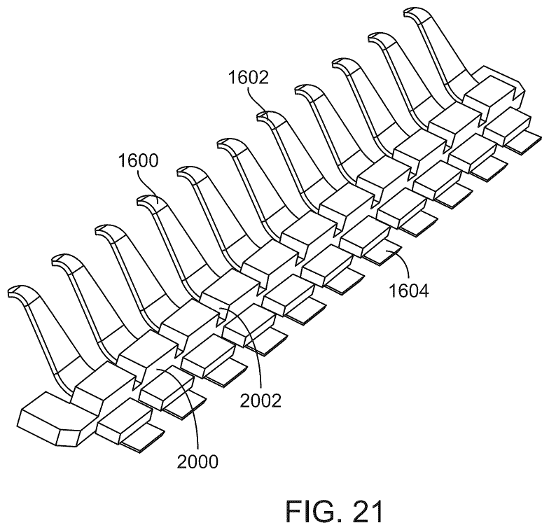

FIG. 13 illustrates another connector system including a connector having a contact array mated with a corresponding flexible circuit board according to an embodiment of the present invention. In this example, connector 1300 can include shell 1310 around frame 1320. Opening 1302 can accept a portion of flexible circuit board 1400. Flexible circuit board 1400 can include cowling or stiffener 1410. Stiffener 1410 can include latches 1412 that can fit in openings 1312 and 1332 in shell 1310. That is, an end of flexible circuit board 1400 and stiffener 1410 can be inserted into opening 1302 in connector 1300, and latches 1412 can fit in openings 1312 and 1332 in shell 1310. This can help to align and secure flexible circuit board 1400 in position in connector 1300. Board 1500 can be a printed circuit board, flexible circuit board, or other appropriate substrate. Traces and pads (not shown) in printed circuit board 1500 can connect to contacts (not shown) on a surface of printed circuit board 1500 as well as components and circuits (not shown) on printed circuit board 1500. These contacts can be soldered to surface-mount contacting portions 1604 (shown in FIG. 21) of contacts 1600 (shown in FIG. 21.) Contacting portions 1602 (shown in FIG. 21) of contacts 1600 can physically and electrically connect to contacts 1404 (shown in FIG. 15) on a bottom side of flexible circuit board 1400. Contacts 1404 on the bottom side of flexible circuit board 1400 can connect to other circuits and components (not shown) via traces (not shown) of flexible circuit board 1400.

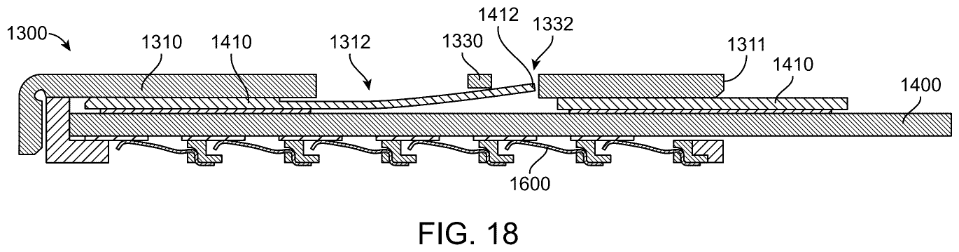

As compared to connector 100, connector 1300 is shown as having two openings 1312 and 1332 for each latch 1412 on stiffener 1410. These openings 1312 and 1332 can be separated by shell crossbar 1330. Shell crossbar 1330 can control a vertical height of latch 1412 in openings 1312 and 1332. For example, shell crossbar 1330 can prevent latch 1412 from extending above a top surface of shell 1310. This is shown further in FIG. 18 below.

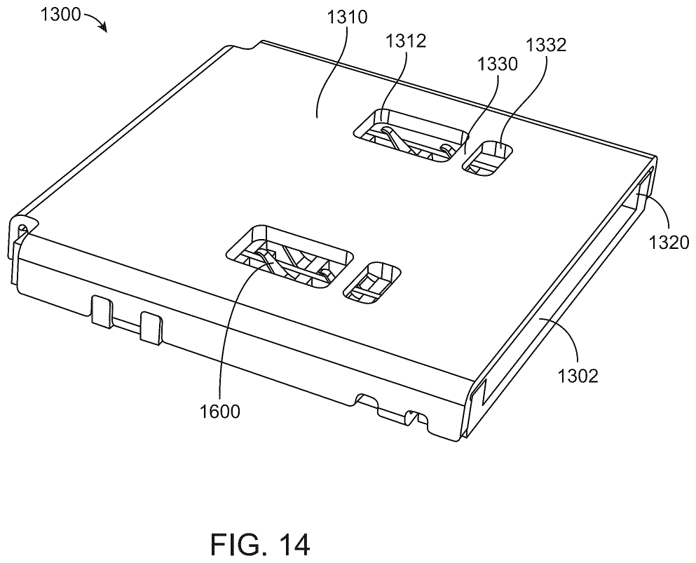

FIG. 14 illustrates a front oblique view of a connector according to an embodiment of the present invention. Connector 1300 can include frame 1320 protected by shell 1310. Frame 1320 can support an array of contacts 1600, which can be physically and electrically connected to contacts 1404 (shown in FIG. 15) on a bottom side of flexible circuit board 1400 (shown in FIG. 13) when flexible circuit board 1400 is inserted in opening 1302. Shell 1310 can include openings 1312 and 1332, which can be separated by shell crossbar 1330, and which can accept latches 1412 on stiffener 1410 on flexible circuit board 1400 (all shown in FIG. 13.)

FIG. 15 illustrates a portion of a flexible circuit board according to an embodiment of the present invention. Contacts 1404 can be located on an end or tab portion 1402 of flexible circuit board 1400. Contacts 1404 can be connected to traces (not shown) in flexible circuit board 1400. Contacts 1404 can be connected through these traces to circuits, contacts, and other electrical components in an electronic device housing connector 1300.

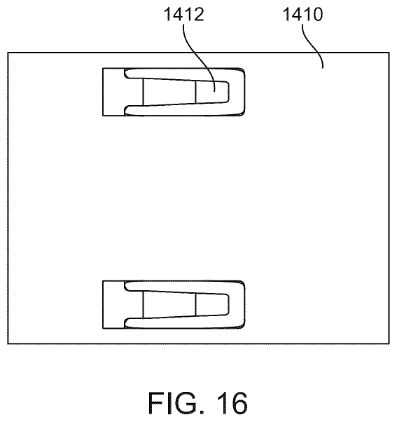

FIG. 16 illustrates a stiffener for a portion of a flexible circuit board according to an embodiment of the present invention. Stiffener 1410 can include latches 1412. Latches 1412 can be stamped or otherwise formed from stiffener 1410, or latches 1412 can be attached to stiffener 1410.

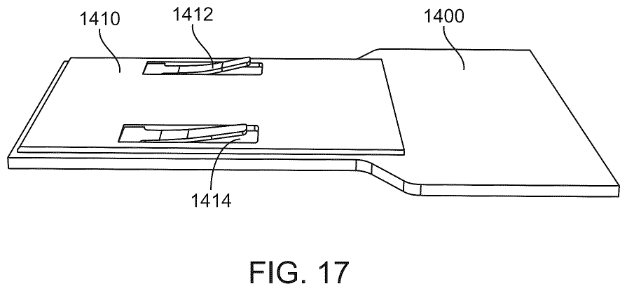

FIG. 17 illustrates a portion of a flexible circuit board and stiffener according to an embodiment of the present invention. In this example, stiffener 1410 can be attached to flexible circuit board 1400. Stiffener 1410 can be attached using adhesive or other material (not shown.) For example, stiffener 1410 can be attached to flexible circuit board 1400 using a conductive or nonconductive adhesive, such as a conductive pressure-sensitive adhesive, a conductive temperature-sensitive or heat-activated adhesive, or other adhesive layer. Openings 1414 can be formed in stiffener 1410 and latches 1412 can be formed by lifting or bending.

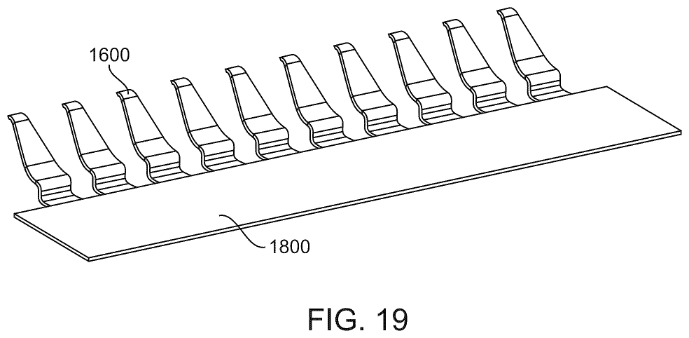

FIG. 18 illustrates a side view of a flexible circuit board mated with a connector according to an embodiment of the present invention. In this example, flexible circuit board 1400 can be mated with connector 1300, that is, flexible circuit board 1400 can be inserted into connector 1300. During insertion of flexible circuit board 1400 into connector 1300, latch 1412 of stiffener 1410 can encounter front edge 1311 of shell 1310 of connector 1300. Front edge 1311 can push latch 1412 downward as shown. When latch 1412 reaches openings 1312 and 1332 in shell 1310, latch 1412 can move upward to its original position. This upward travel can be limited by shell crossbar 1330. Latch 1412 in openings 1312 and 1332 in shell 1310 can help to secure flexible circuit board 1400 in place in connector 1300. Once in place, contacts 1404 on flexible circuit board 1400 (shown in FIG. 15) can form electrical connections with contacting portions 1602 (shown in FIG. 19) of contacts 1600 of connector 1300. Flexible circuit board 1400 can be removed for rework by pushing latch 1412 against the stiffener 1410 and extracting flexible circuit board 1400 from the connector 1300.

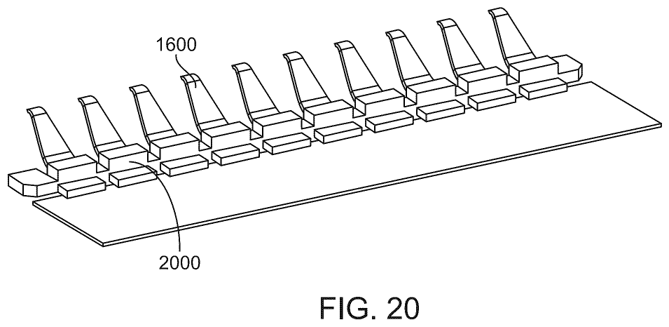

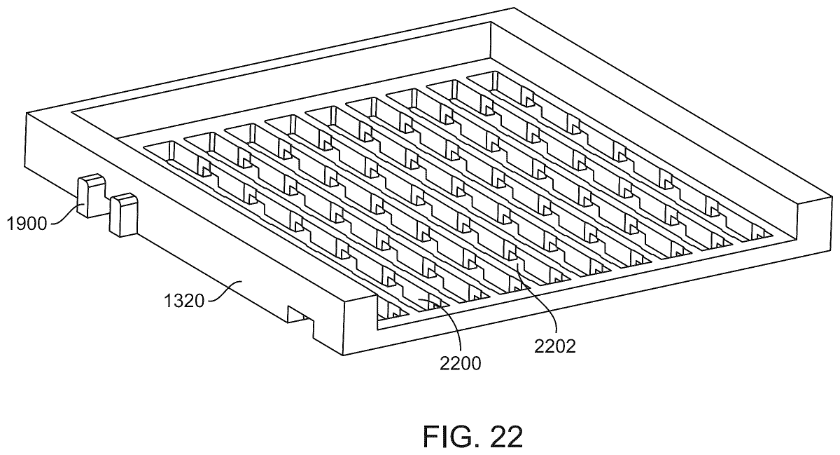

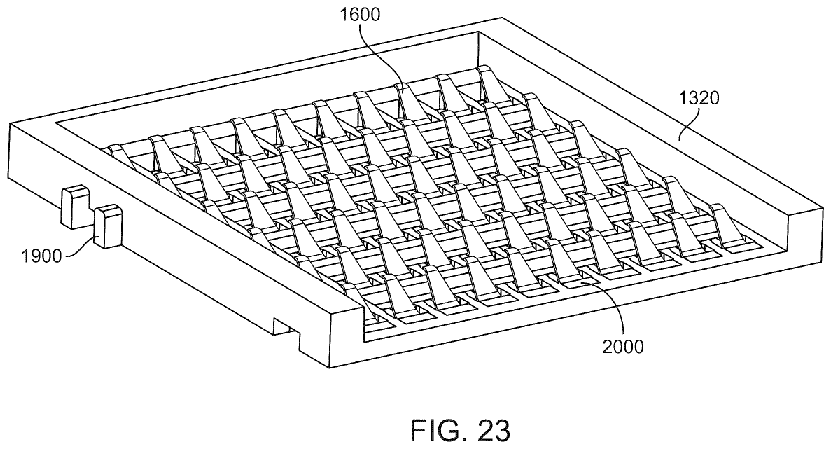

FIG. 19 through FIG. 23 illustrate another method of manufacturing a connector according to an embodiment of the present invention. In FIG. 19, a number of contacts 1600 can be formed. A sheet of metal can be stamped to form contacts 1600 and carrier 1800. Contacts 1600 can be held in place relative to each other for further manufacturing steps by carrier 1800. In FIG. 20, contacts 1600 can be supported by array crossbar 2000, which can be formed by insert or injection molding or other manufacturing process around a portion of each contact 1600. In FIG. 21, contacts 1600 can be separated from carrier 1800, and carrier 1800 can be recycled. Each contact 1600 can include a contacting portion 1602 for mating with a corresponding contact 1404 on a bottom surface of flexible circuit board 1400, as shown in FIG. 15. Contacts 1600 can also include a surface-mount contacting portions 1604 at an opposite end, though contacts 1600 can instead have through-hole contacting portions (not shown.) Surface-mount contacting portions 1604 can be soldered to a corresponding contact (not shown) on printed circuit board 1500 (shown in FIG. 13) or other appropriate substrate. Contacts 1600 can be supported by array crossbar 2000. Array crossbar 2000 can have notches 2002. In FIG. 22, frame 1320 can be formed. Frame 1320 can further include protrusions 1900 for aligning to shell 1310, as shown with respect to connector 100 in FIG. 10. Frame 1320 can include slats 2200 having notches 2202. In FIG. 23, contacts 1600 and array crossbars 2000 can be fit to slats 2200 in frame 1320. Again, Frame 1320 can further include protrusions 1900 for aligning to shell 1310. In these and other embodiments of the present invention, frame 1320 can be insert or injection molded around array crossbars 2000.

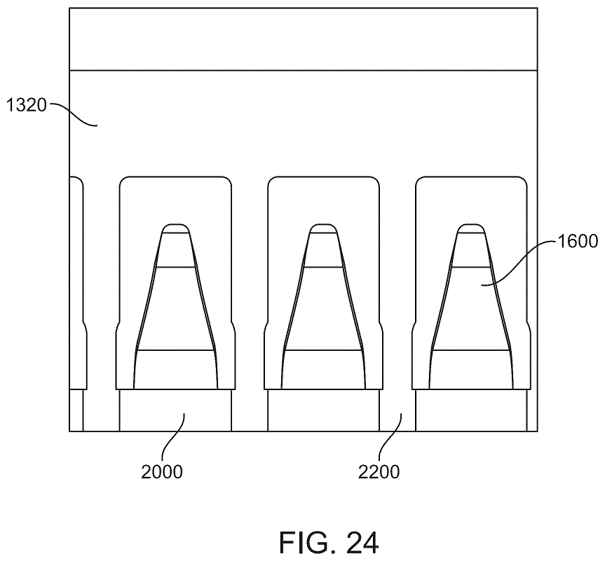

FIG. 24 is a detail view of a portion of a frame and contacts for a connector according to an embodiment of the present invention. Contacts 1600 can be held in place in frame 1320 by array crossbar 2000. Notches 2002 (shown in FIG. 21) in array crossbar 2000 can accept slats 2200. Notches 2202 (shown in FIG. 22) in slats 2200 can accept array crossbar 2000. These interlocking features can help to secure connector 1300 (shown in FIG. 13) as a single piece.

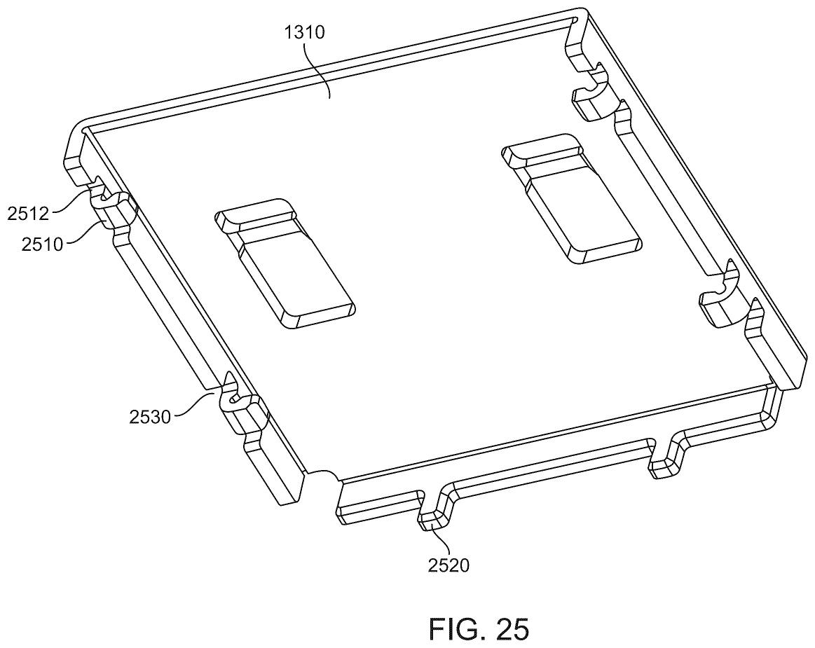

FIG. 25 illustrates a shell for a connector according to an embodiment of the present invention. Shell 1310 can be fit over the frame 1320 of FIG. 23. Shell 1310 can include tab 2510. Tab 2510 can fit between protrusions 1900 (shown in FIG. 23) to be aligned to frame 1320. Protrusions 1900 can fit in openings 2512 in shell 1310. Tab 2510 can be bent around an underside of frame 1320. A corresponding recess 1120 (shown in FIG. 11 for connector 100 shown in FIG. 1) in frame 1320 can be formed to accept tab 2510 such that tab 2510 does not lift connector 1300 off a printed circuit board 1500 (shown in FIG. 13) or other appropriate substrate. Tabs 2510 can be soldered to a corresponding contact on the printed circuit board. Tabs 2510 can be planarized for mating with printed circuit board 1500. Tabs 2520 can be inserted into openings (not shown) and soldered in place in printed circuit board 1500.

A height of connector 1300 (and 100, shown in FIG. 1) can be well-controlled. For example, the height of connector 1300 (shown in FIG. 13) can be dictated by the position of tabs 2510 and a top of shell 1310. This well controlled height can provide a reliable connection between contacts 1600 (shown in FIG. 13) in connector 1300 and contacts 1404 on flexible circuit board 1400 (shown in FIG. 15.) This height control can provide a connector 1300 that can reliably accept flexible circuit board 1400 (shown in FIG. 13) without damaging flexible circuit board 1400 and with a consistent and reliable insertion force.

The tolerances between protrusions 1900 (shown in FIG. 23) and openings 2512 can be tight. This can help to keep shell 1310 and frame 1320 aligned during a reflow process. In this example, corresponding protrusions from frame 1320 might not be used in openings 2530. This can help to prevent warping of frame 1320 during reflow. That is, this can allow frame 1320 to expand relative to shell 1310 without causing frame 1320 to warp during reflow.

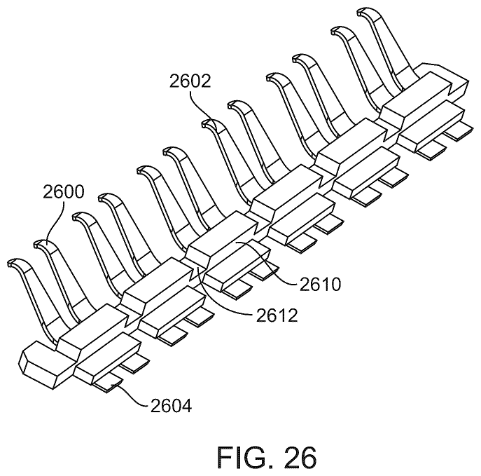

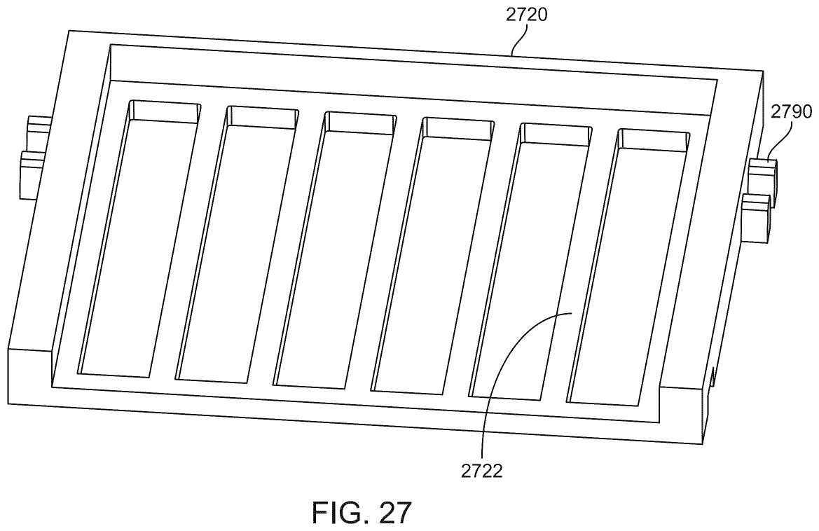

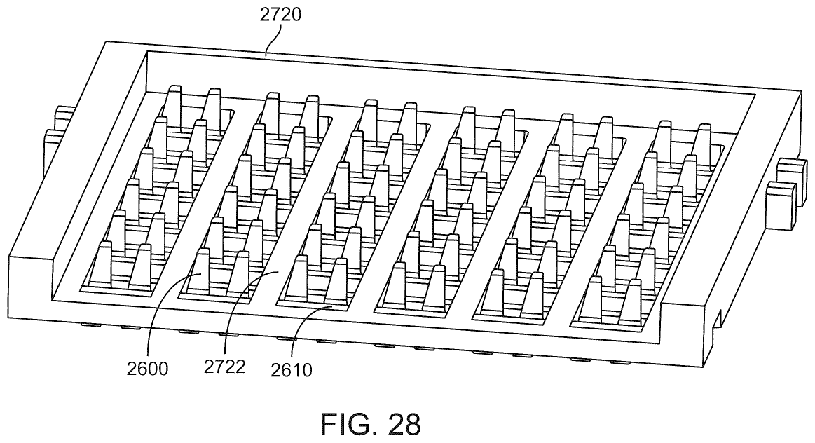

FIG. 26 through FIG. 28 illustrate another method of manufacturing a connector according to an embodiment of the present invention. In FIG. 26, contacts 2600 can be separated from a carrier (not shown) and the carrier can be recycled. Each contact 2600 can include a contacting portion 2602 for mating with a corresponding contact 1404 on a bottom surface of flexible circuit board 1400, as shown in FIG. 15. Contacts 2600 can also include a surface-mount contacting portions 2604 at an opposite end, though contacts 2600 can instead have through-hole contacting portions (not shown.) Surface-mount contacting portions 2604 can be soldered to a corresponding contact (not shown) on printed circuit board 1500 (shown in FIG. 13) or other appropriate substrate. Contacts 2600 can be supported by array crossbar 2610. Array crossbar 2610 can have notches 2612. In FIG. 27, frame 2720 can be used in the same and similar way as frame 120 of connector 100 (shown in FIG. 1), frame 3200 (shown in FIG. 34), frame 1320 of connector 1300 (shown in FIG. 13), and other frames consistent with embodiments of the present invention. Frame 2720 can include slats 2722. Frame 2720 can also include protrusions 2790, which can be used in the same or similar way as protrusions 900 in FIGS. 11 and 1900 in FIG. 23. In FIG. 28, array crossbars 2610 and contacts 2600 can be fit to slats 2722 in frame 2720. Notches 2612 in array crossbars 2610 can accept slats 2722. In these and other embodiments of the present invention, frame 2720 can be insert or injection molded around array crossbars 2610. These interlocking features can help to secure connector 1300 (shown in FIG. 13) as a single piece.

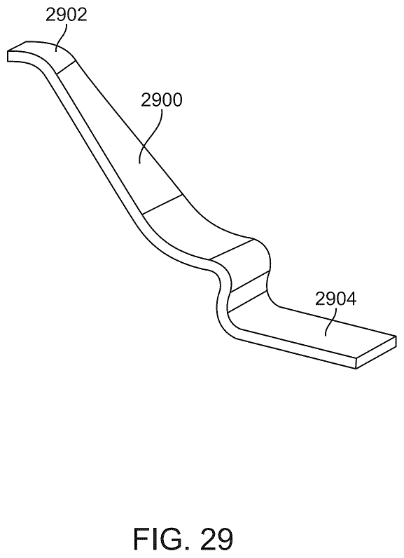

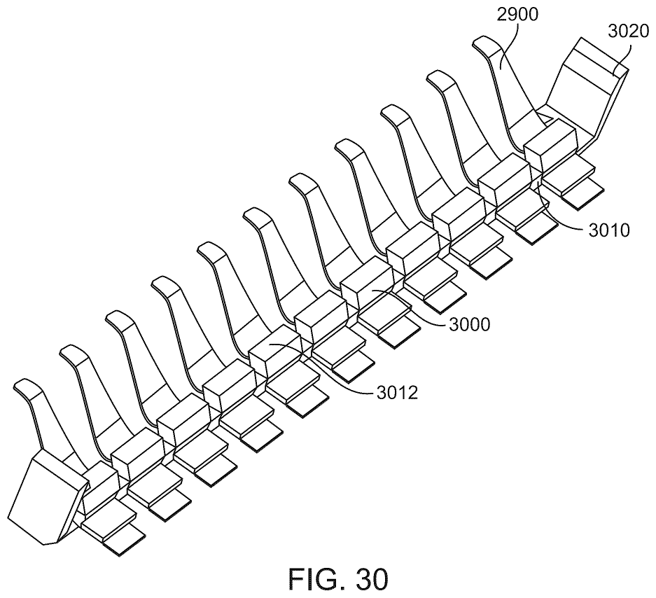

FIG. 29 through FIG. 32 illustrates a method of manufacturing a connector according to an embodiment of the present invention. In FIG. 29, contact 2900 can be formed. Each contact 2900 can include a contacting portion 2902 for mating with a corresponding contact 1404 on a bottom side of flexible circuit board 1400, as shown in FIG. 15. Contacts 2900 can also include a surface-mount contacting portions 2904 at an opposite end, though contacts 2900 can instead have through-hole contacting portions (not shown.) Surface-mount contacting portions 2904 can be soldered to a corresponding contact (not shown) on a printed circuit board 1500 (shown in FIG. 13) or other appropriate substrate. Contact 2900 can be stamped, forged, 3-D printed, or formed in other ways. In FIG. 30, contacts 2900 can be held in place relative to each other by array crossbar 3000. Array crossbar 3000 can be formed by injection or insert molding or by using other methods or techniques. Array crossbar 3000 can be formed around stamped contacts 2900, or contacts 2900 can be stamped after array crossbar 3000 is formed. Array crossbar 3000 can include notches 3010 and end tabs 3020. Notches 3010 can define thicker portions 3012, which can support contacts 2900.

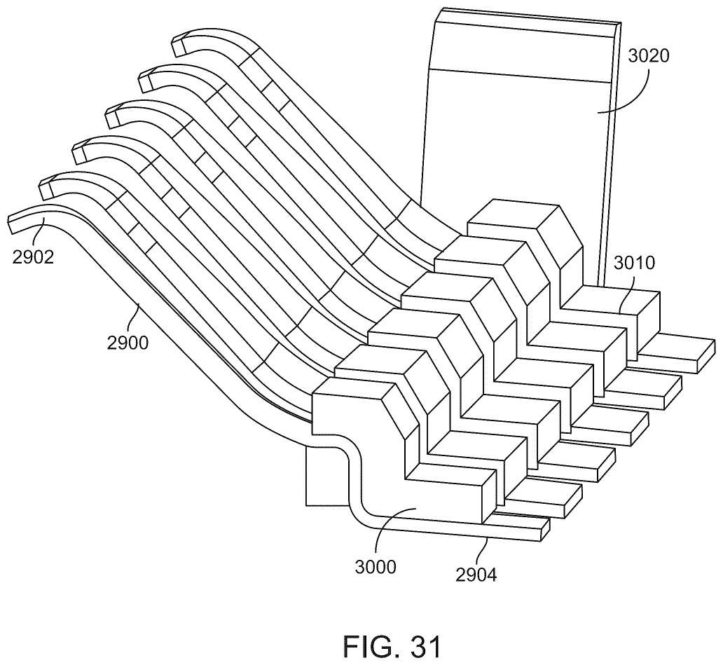

FIG. 31 illustrates a side view of the structure of FIG. 30. Contacts 2900 can be held in place by array crossbar 3000. Contacts 2900 can include contacting portions 2902 and surface-mount contacting portions 2904. Array crossbar 3000 can again include notches 3010 and end tabs 3020.

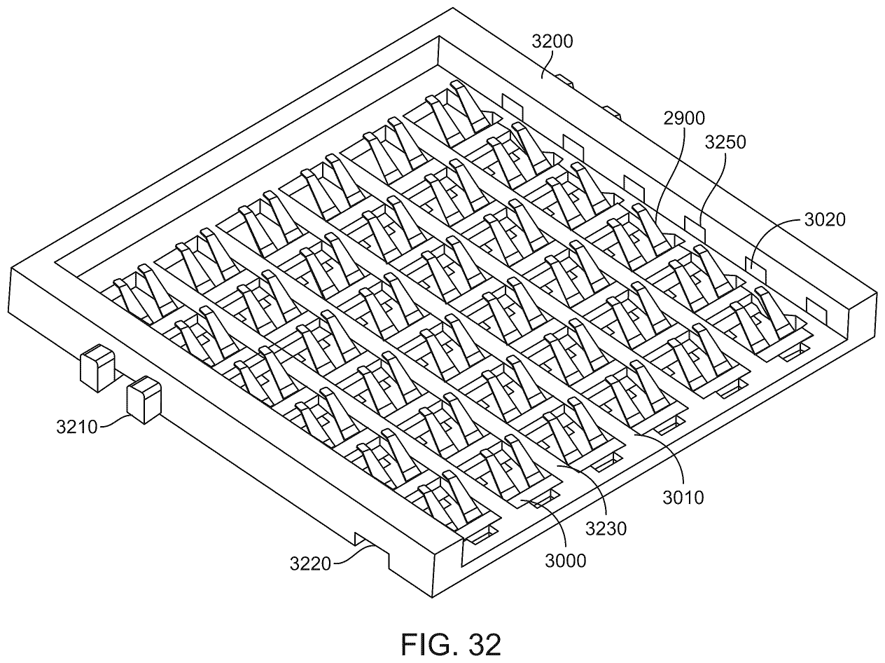

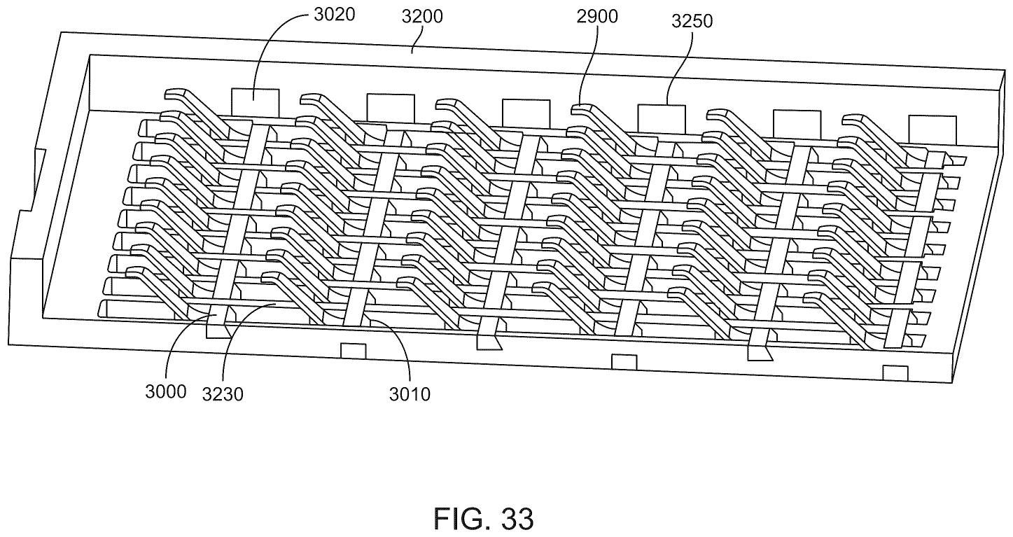

In FIG. 32, frame 3200 can be placed or formed around array crossbars 3000 and contacts 2900. Frame 3200 can be injection or insert molded around array crossbars 3000. Alternatively, frame 3200 can be individually formed as a separate piece and then array crossbars 3000 can be inserted into frame 3200. Frame 3200 can include tabs or protrusions 3210 and notches 3220. Tabs or protrusions 3210 and notches 3220 can be the same or similar as tabs or protrusions 900 and openings 1110 (shown in FIG. 12.) End tabs 3020 of array crossbars 3000 can fit into notches 3250 in sides of frame 3200. This can help to secure array crossbars 3000 in place in frame 3200. Slats 3230 can extend across frame 3200 and can fit in notches 3010 of array crossbars 3000. Slats 3230 can extend between each contact of array crossbar 3000 (as shown in FIG. 33), between each pair of contacts of array crossbar 3000 (as shown here) between each group of three contacts of array crossbar 3000, or between other numbers of contacts of array crossbar 3000, where the numbers contacts between slats 3230 can be consistent or vary among slats 3230. The interlocking structure of crossbar notches 3010 and slats 3230 can help to improve a rigidity and reduce warpage of the resulting connector during reflow.

FIG. 33 illustrates a cutaway side view of a connector according to an embodiment of the present invention. Rows of contacts 2900 can be held in place by array crossbars 3000. Array crossbars 3000 can include notches 3010 and end tabs 3020. End tabs 2030 can be inserted into notches 3250 in sides of frame 3200 to help secure array crossbars 3000 in place. Slats 3230 can extend between each contact 2900 and can fit in notches 3010 in array crossbars 3000 to improve a rigidity and reduce warpage of the resulting connector during reflow and other heat inducing steps during device assembly. A shell, such as shell 110 or 1310 can be fit over frame 3200. An example is shown in the following figure.

FIG. 34 illustrates an underside view of a connector according to an embodiment of the present invention. In this example, shell 1310 has been fit to frame 3200. Contacts 2900 can be held in place relative to each other by array crossbars 3000. Contacts 2900 can include surface-mount contacting portions 2904. Slats 3230 can extend between each contact 2900 in a row. Along the sides of frame 3200, tabs 2510 of shell 1310 can be bent to fit between tabs or protrusions 3210 of frame 3200. End tabs 3020 can be inserted into frame 3200 to secure array crossbars 3000 in place.

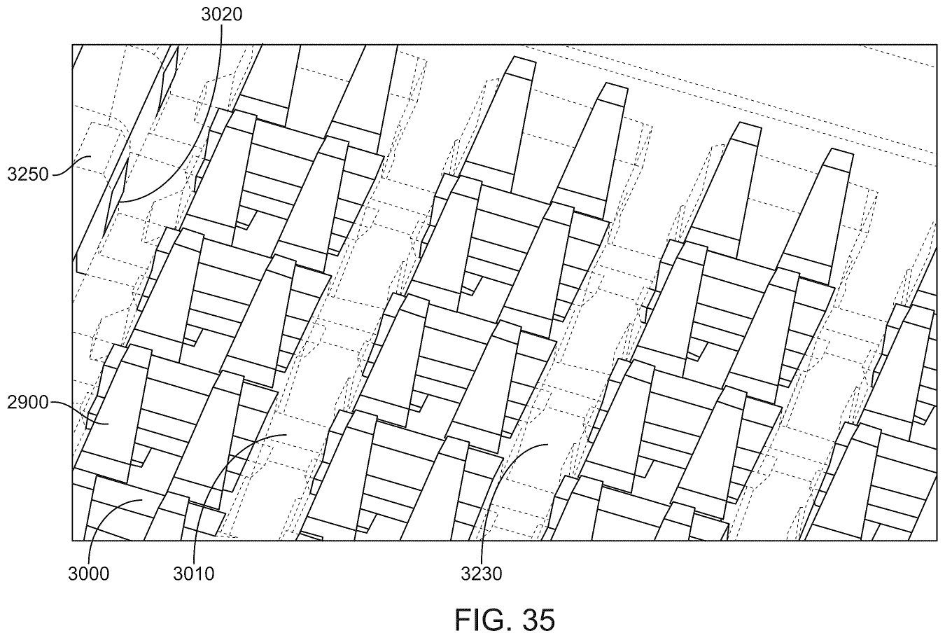

FIG. 35 illustrates a close-up view of a portion of a connector according to an embodiment of the present invention. Contacts 2900 can be held in place by array crossbars 3000. Array crossbars 3000 can include notches 3010. Slats 3230 of frame 3200 shown in FIG. 34) can fit in notches 3010 of array crossbars 3000. End tabs 3020 can fit in notches 3250 in sides of frame 3200 to help secure array crossbars 3000 in place.

In this configuration, array crossbars 3000 can be anchored at each end by end tabs 3020 which can be inserted into frame 3200. Slats 3230 can fit in notches 3010 of array crossbars 3000 forming interlocking feature to help secure array crossbars 3000 in place relative to frame 3200.

In these and other embodiments of the present invention, array crossbars 3000 and slats 3230 can interlock with each other in various ways. Again, array crossbars 3000 can be formed. Frame 3200 can be formed as a separate piece and then array crossbars 3000 can be fit in frame 3200. Alternatively, array crossbars 3000 can be formed and placed in position. Frame 3200 can then be molded around array crossbars 3000. In either event, the interlocking features between slats 3230 of frame 3200 and array crossbars 3000 can be slightly melted to further physically connect these structures. Examples of various interconnect features that can be used are shown in the following figures.

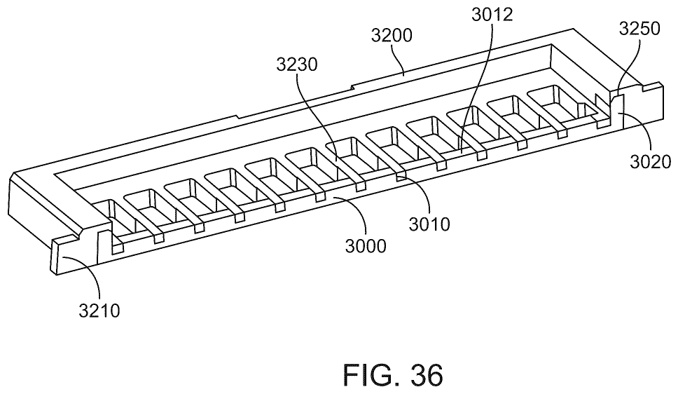

FIG. 36 illustrates a cross-section portion of an array crossbar and a frame according to an embodiment of the present invention. In this example, slats 3230 of frame 3200 can be located in notches 3010 of array crossbars 3000. Array crossbars 3000 can include thicker portions 3012 for supporting contacts 2900, as shown in FIG. 30. Array crossbars 3000 can include end tabs 3020 which can fit in notches 3250 in frame 3200. Tabs or protrusions 3210 can extend from sides of frame 3200. In this configuration, each slat 3230 can fit in a notch 3010 in a top side of array crossbar 3000. As before, array crossbars 3000 can be arranged and fit to frame 3200. Alternatively, frame 3200 can be injection molded around a number of array crossbars 3000.

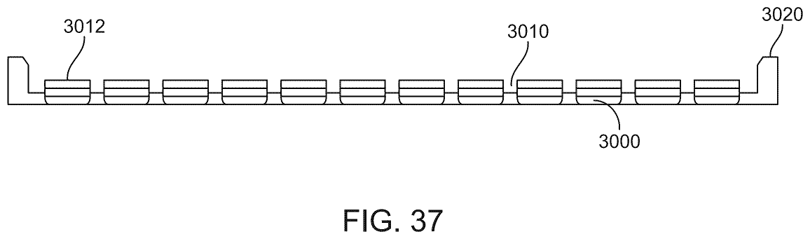

FIG. 37 illustrates an array crossbar according to an embodiment of the present invention. Array crossbar 3000 can include notches 3010 along a top side. Notches 3010 can define thicker portions 3012. Thicker portions 3012 can support contacts 2900, as shown in FIG. 30. Array crossbar 3000 can further include end tabs 3020, which can fit in notches 3250 in frame 3200, as shown in FIG. 36.

Instead of slats 3230 fitting in notches 3010 in a top side of array crossbar 3000, slats 3230 can instead fit in alternating notches in a top or bottom side of array crossbar 3000. This interlocking feature can help to prevent warpage of a resulting connector during reflow and other manufacturing steps. These interlocking patterns can also improve the strength and durability of the resulting connector, thereby improving its yield and lifetime as well as improving an ability to rework components associated with the connector in a more reliable manner. An example is shown in the following figure.

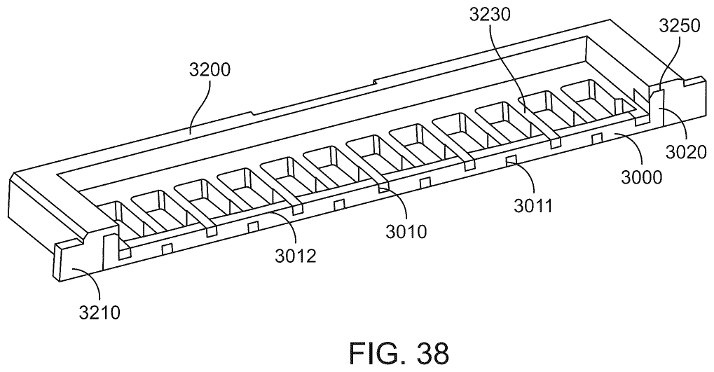

FIG. 38 illustrates a cross-section of an array crossbar and frame according to an embodiment of the present invention. In this example, slats 3230 of frame 3200 can be located in notches 3010 and notches 3011 in array crossbar 3000. Notches 3010 can be formed in a top side of array crossbar 3000, while notches 3011 can be formed in a bottom side of array crossbar 3000. Notches 3010 and 3011 can define thicker portions 3012, which can support contacts 2900, as shown in FIG. 30. Notches 3010 and 3011 can alternate as shown. In these and other embodiments of the present invention, notches 3010 and 3011 can alternate in other patterns. For example, pairs of notches 3010 can alternate with pairs of notches 3011. Array crossbars 3000 can again include end tabs 3020, which can fit in notch is 3250 in frame 3200. Frame 3200 can further include tabs or protrusions 3210.

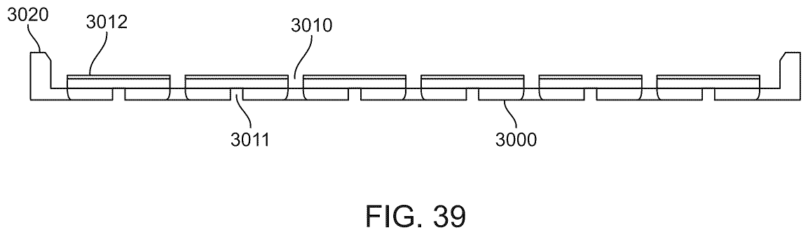

FIG. 39 illustrates an array crossbar according to an embodiment of the present invention. Array crossbar 3000 can include notches 3010 along a top side, and notches 3011 along a bottom side. Notches 3010 and notches 3011 can defined thicker portions 3012, which can support contacts 2900, as shown in FIG. 30. Array crossbars 3000 can further include end tabs 3020, which can fit in notches 3250 in frame 3200, as shown in FIG. 38.

The above figures illustrate interlocking patterns that can be used to interlock a number of slats with a single array crossbar. These and similar interlocking patterns can further be utilized to interlock a number of array crossbars with a single slat. Examples are shown in the following figures.

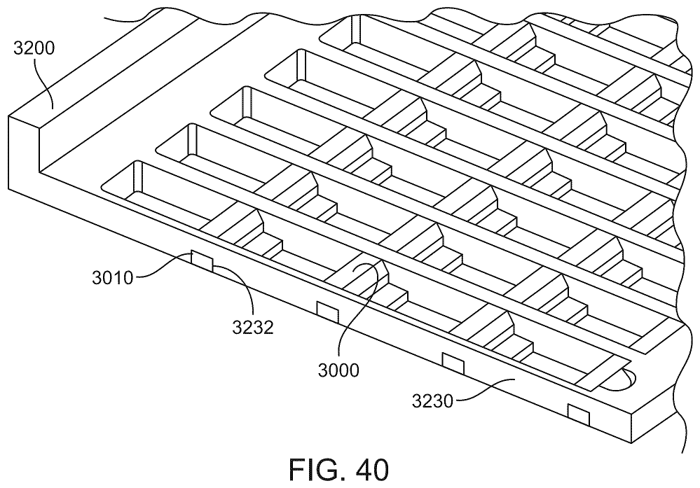

FIG. 40 illustrates a cross-section of a slat in a frame according to an embodiment of the present invention. In this example, a number of array crossbars 3000 of frame 3200 can be held together by slats 3230. Slats 3230 can include notches 3232 that can accept notches 3010 of array crossbars 3000. Each of the notches 3232 can be formed in a bottom side of slats 3230. In these and other embodiments of the present invention, other interlocking patterns can be used. An example shown in the following figure.

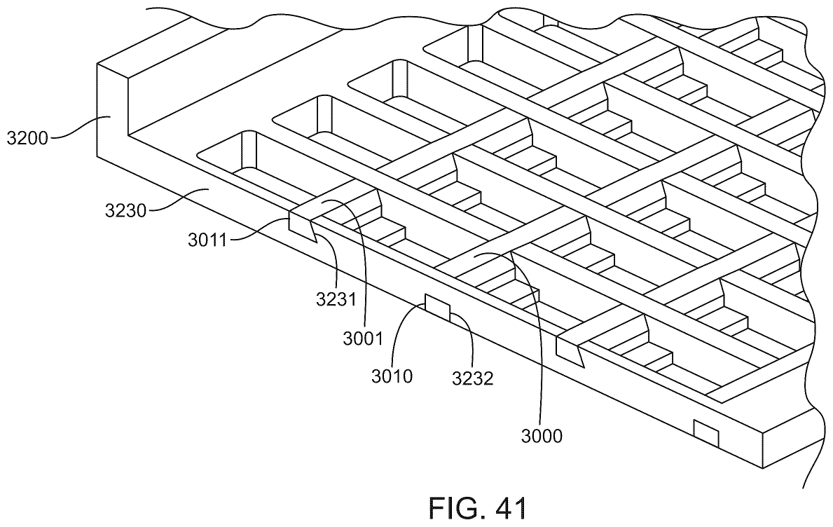

FIG. 41 illustrates a cross-section of a slat in a frame according to an embodiment of the present invention. In this example, number of array crossbars 3000 and array crossbars 3001 of frame 3200 can be held together by slats 3230. Slats 3230 can include notches 3232 in a bottom side, and notches 3231 in a top side. Notches 3232 can accept notches 3010 of array crossbars 3000. Array crossbar 3001 can be of similar construction is array crossbar 3000 and can be arranged such that notches 3011 of array crossbar 3001 fit in notches 3231 in a top of slats 3230.

In this configuration, array crossbars 3000 and 3001 can include notches that alternatively fit in notches in a top and bottom side of slat 3230. This interlocking feature can help to prevent warpage of a resulting connector during brief flow and other manufacturing steps. These interlocking patterns can further improve the strength and durability of the resulting connector, thereby improving its yield and lifetime, as well as improving and ability to rework components associated with the connector in a more reliable manner.

In several of the above configurations, such as the configuration shown in FIG. 35, contacts 2900 can be grouped in pairs between slats 3230 in frame 3200. This can be useful when pairs of contacts 2900 convey differential signals. Example pinouts that can take advantage of this and other improvements provided by these connectors are shown in the following figures.

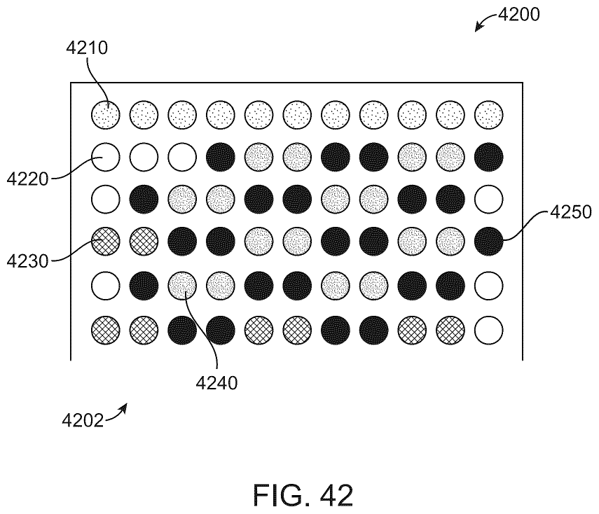

FIG. 42 is a pinout for a contact array of a connector according to an embodiment of the present invention. This pinout can be particularly useful for contacts 300 when frame 120 is used in connector 100 (shown in FIG. 1), for contacts 1600 when frame 1320 is used in connector 1300 (shown in FIG. 13), or when contacts 2900 are used in frame 3200 (as shown in FIG. 32.) A flexible circuit board, such as flexible circuit board 200 (shown in FIG. 1) or 1400 (shown in FIG. 13), can be inserted into opening 4202 of connector 4200, which can be the same or similar to connector 100, connector 1300 or a connector using frame 3200 in FIG. 32. In this example, the back row of contacts 4210 can be used as power contacts. This placement ensures that power is not connected between flexible circuit board 200 and connector 100 (shown in FIG. 1) or between flexible circuit board 1400 and connector 1300 (shown in FIG. 13) until the other connections are made as well. High-speed differential signals can be conveyed on contacts 4240. These high-speed differential signals can be shielded by grounds on contacts 4250. Low-speed differential signals can be conveyed on contacts 4230. Other data lines, such as single-ended data lines can be conveyed on contacts 4220.

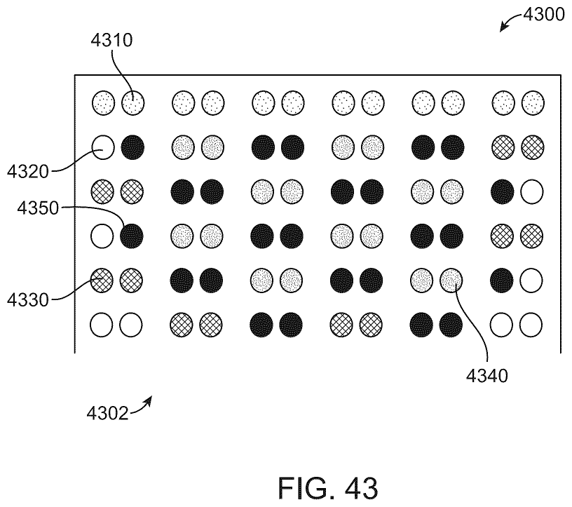

FIG. 43 is another pinout for a contact array of a connector according to an embodiment of the present invention. This pinout can be particularly useful for contacts 2600 when frame 2720 is used in connector 100 (shown in FIG. 1), connector 1300 (shown in FIG. 13), or a connector that includes the frame 3200 as shown in FIG. 34. A flexible circuit board, such as flexible circuit board 200 (shown in FIG. 1) or 1400 (shown in FIG. 13), can be inserted into opening 4302 of connector 4300, which can be the same or similar to connector 100 or connector 1300. In this example, the back row of contacts 4310 can be used as power contacts. This placement ensures that power is not connected between flexible circuit board 200 and connector 100 (shown in FIG. 1) or between flexible circuit board 1400 and connector 1300 (shown in FIG. 13) until the other connections are made as well. High-speed differential signals can be conveyed on contacts 4340. These high-speed differential signals can be shielded by grounds on contacts 4350. Low-speed differential signals can be conveyed on contacts 4330. Other data lines, such as single-ended data lines can be conveyed on contacts 4320.

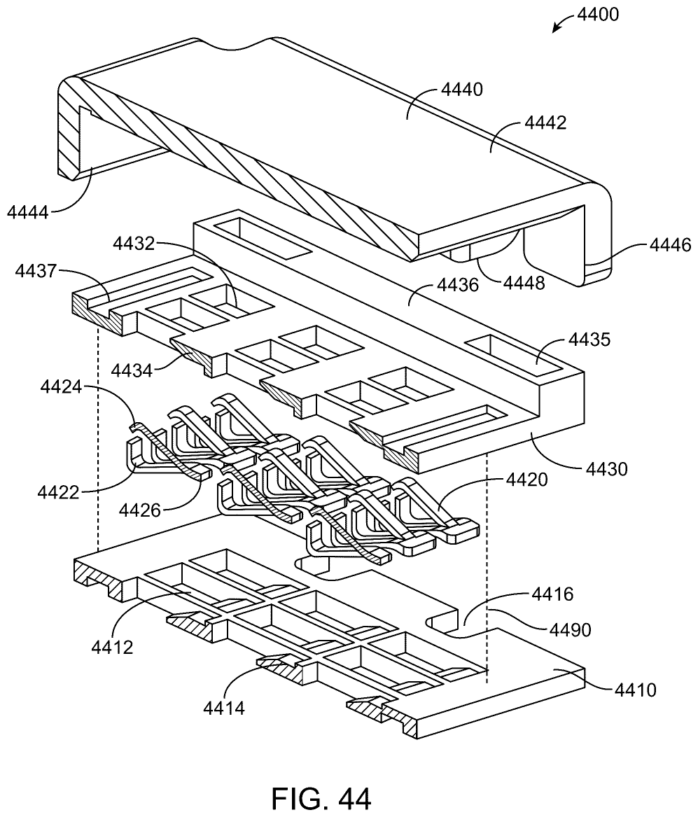

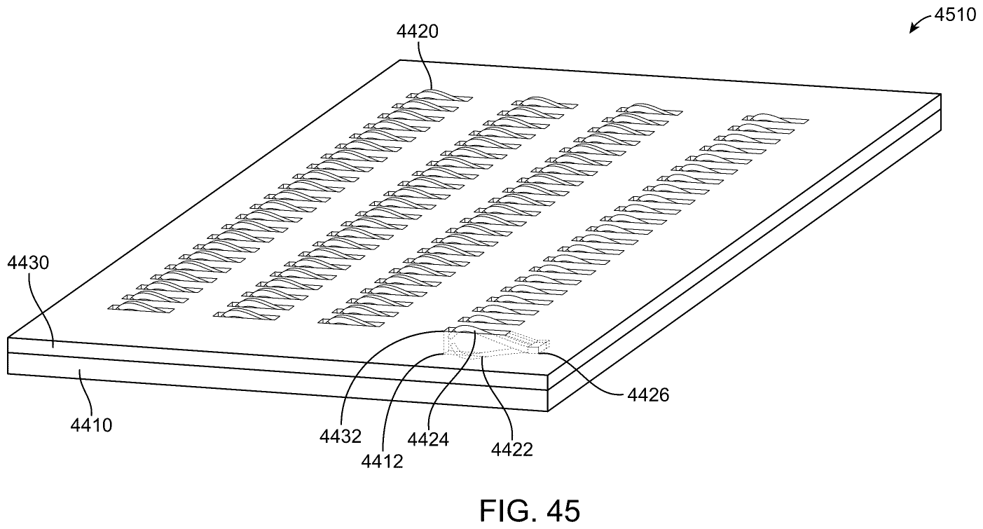

FIG. 44 illustrates a portion of a connector according to an embodiment of the present invention. Connector 4400, which can be referred to as a connector receptacle, can include bottom frame 4410 and top frame 4430, along with contacts 4420, to collectively form frame 4510 (shown in FIG. 45.) Bottom frame 4410 and top frame 4430 can hold contacts 4420 in place. Bottom frame 4410 and top frame 4430 can be covered by shell 4440.

Bottom frame 4410 can include a number of openings 4412. Each opening 4412 can be used to provide access to a contact 4420, though in various embodiments some openings 4412 might not have a contact while other openings 4412 might have more than one contact. Each opening 4412 can include a bottom ledge 4414. Each bottom ledge 4414 can support an end 4426 of a contact 4420. Bottom frame 4410 can include notch 4416 into which folded tab 4448 on shell 4440 can fit.

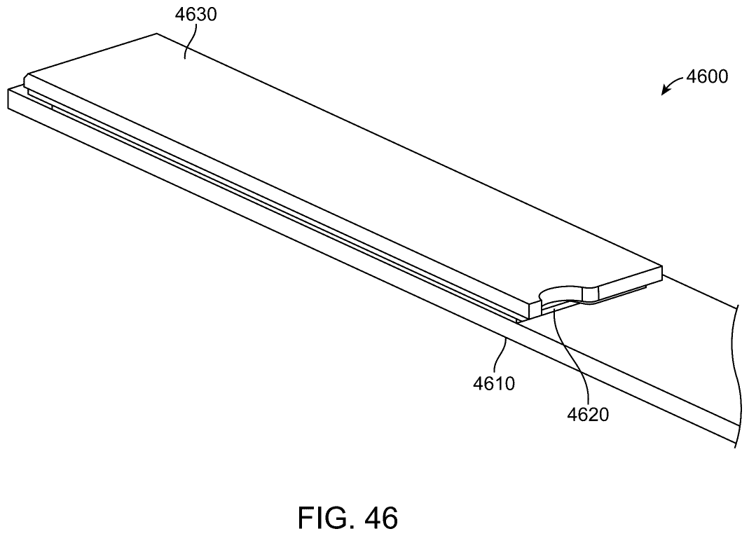

Contacts 4420 can each include a bottom contacting portion 4422 that can connect to a pad or contact on a board (not shown) that supports connector 4400. The board can be a printed circuit board, a flexible circuit board, a flexible circuit board having a stiffener or cowling, or other appropriate substrate. Bottom contacting portions 4422 can be soldered to the pads or contacts on the printed circuit board, or bottom contacting portions 4422 can simply be in contact with the pads or contacts on the printed circuit board. The pads or contacts on the board, which can be a main logic board or other type of board, can be connected to other components through traces of the board. Contacts 4420 can each include a top contacting portion 4424 that can contact a pad or contact (not shown) on a bottom of flexible circuit board 4610 (shown in FIG. 46) that is inserted into connector 4400. Contact 4420 can be compliant or flexible and can be compressed to help ensure that a good connection is formed between a top contacting portion 4424 and a pad or contact on flexible circuit board 4610 and between a bottom contacting portion 4422 and a pad or contact on the printed circuit board. The pads or contacts on flexible circuit board 4610 can be connected to traces (not shown) of flexible circuit board 4610 that can route signals and other voltages in an electronic device. In this way, traces of the printed circuit board can be connected to traces of the flexible circuit board 4610 via contacts 4420 to convey signals and other voltages.

Top frame 4430 can include a number of openings 4432 corresponding to openings 4412 in bottom frame 4410. Each opening 4432 in top frame 4430 can include a top ledge 4434. An end 4426 of each contact 4420 can be held in place between a top ledge 4434 in top frame 4430 and a bottom ledge 4414 in bottom frame 4410. A top contacting portion 4424 of each contact 4420 can be exposed at an opening 4432 in top frame 4430 and a bottom contacting portion 4422 of each contact 4420 can be exposed at an opening 4412 in bottom frame 4410. Top frame 4430 can include side rails 4436 for additional mechanical support and as a guide for flexible circuit board plug 4600 (shown in FIG. 46.) Side rails 4436 can be on each of two opposite sides or ends of top frame 4430. A similarly structured back rail (not shown) can be positioned along a backside of top frame 4430 near back tabs 4444 for additional mechanical support and as a guide for flexible circuit board plug 4600. Side rails 4436 can include notches 4435. Top frame 4430 can further include notches 4437.

Shell 4440 can include top 4442, side tabs 4446, and one or more back tabs 4444. Side tabs 4446 can be located along sides of frame 4510 while the one or more back tabs 4444 can be along a back side of frame 4510. Side tabs 4446 and back tabs 4444 can be soldered to ground contacts or pads on a surface of the printed circuit board. Shell 4440 can further include bent tabs 4448 that can be folded under shell 4440 such that they fit in notches 4416 in bottom frame 4410. By folding around a side rail 4436 of top frame 4430, bent tabs 4448 can help to secure frame 4510 in place. Fitting into notch 4416 allows tabs 4448 to have a bottom surface that lies in the same plane as bottom contacting portions 4422 of contacts 4420. This can help to provide connector 4400 with a low-height. For example, connector 4400 can have a height that is approximately 1 mm.

During assembly, contacts 4420 can be placed in openings 4412 in bottom frame 4410. In these and other embodiments of the present invention, different numbers of contacts can be used. For example, connector 4400 can include 49, 810, 100, 144, or other numbers of contacts. Top frame 4430 can be placed on top of bottom frame 4410 such that ends 4426 of contacts 4420 are each secured between a bottom ledge 4414 of bottom frame 4410 and a top ledge 4434 of top frame 4430. Top frame 4430 can be laser welded to bottom frame 4410 at locations identified by lines 4490. For example, top frame 4430 can be laser welded to bottom frame 4410 at locations in notches 4435 in side rails 4436 in top frame 4430 and notches 4437 and in top frame 4430. Notches 4435 and notches 4437 can provide thinned regions of top frame 4430 to facilitate this laser welding. Shell 4440 can be formed and frame 4510 can be placed adjacent. Tabs 4448 can be bent around side rail 4436 of top frame 4430 and into notches 4416 in bottom frame 4410 to secure shell 4440 to frame 4510.

Bottom frame 4410 and top frame 4430 can be formed of plastic, nylon, glass-filled nylon, or other material. Top frame 4430 and bottom frame 4410 can be a material having a low dielectric constant to reduce capacitive coupling between contacts 4420. Top frame 4430 and bottom frame 4410 can be formed using molding, injection molding, 3-D printing, or other process. Contacts 4420 can be formed of stainless steel, copper, copper alloy, such as a titanium copper alloy, copper zinc alloy, copper tin alloy, copper nickel alloy, or other alloy or other conductive material. Contacts 4420 can be at least partially plated with gold or other material. Contacts 4420 can be formed by stamping, metal-injection molding, stamping, deep drawing, forging, 3-D printing, or other process. Shell 4440 can be formed of stainless steel, copper, copper alloy, or other material. Shell 4440 can be formed by stamping, deep drawing, machining, 3-D printing, or other technique.

FIG. 45 illustrates a portion of the connector of FIG. 44. Top frame 4430 can be attached to bottom frame 4410 to secure contacts 4420 in place and to form frame 4510. Contacts 4420 can include top contacting portion 4424 and bottom contacting portions 4422 that can be exposed at openings 4432 in a top of top frame 4430 and at openings 4412 in a bottom of bottom frame 4410, respectively. Contacts 4420 can include ends 4426 that can be secured between top ledges 4434 (shown in FIG. 44) of top frame 4430 and bottom ledges 4414 (shown in FIG. 44) of bottom frame 4410.

Frame 4510, including top frame 4430, bottom frame 4410, and contacts 4420, can be used without shell 4440 (shown in FIG. 44.) For example, frame 4510 can be positioned between a first board and a second board (not shown.) Fasteners can pass through one or more openings in frame 4510 from the first board to the second board to attach the first board to the second board with frame 4510 positioned as an interposer. Contacts 4420 of frame 4510 can provide connections from pads or contacts (not shown) on the first board to pads or contacts (not shown) on the second board. The first board and the second board can each be a printed circuit board, a flexible circuit board, a flexible circuit board having a stiffener or cowling, or other appropriate substrate. The first board and the second board can be the same type of board or they can be different types of boards. When frame 4510 is used as an interposer, side rails 4436 (shown in FIG. 44) can be omitted, as shown here, to allow a board to be positioned flush on a top surface of top frame 4430 of frame 4510. When frame 4510 is used with shell 4440, optional side rails 4436 can be included on a top surface of top frame 4430 to guide and position flexible circuit board plug 4600 (shown in FIG. 46.) A similarly structured back rail (not shown) can be placed along a backside of the top surface of top frame 4430.

FIG. 46 illustrates a portion of a flexible circuit board plug according to an embodiment of the present invention. Flexible circuit board plug 4600 can include flexible circuit board 4610 and cowling or stiffener 4630. Cowling or stiffener 4630 can be held in place on flexible circuit board 4610 using adhesive 4620. Flexible circuit board plug 4600 can be inserted into connector 4400 by fitting between top frame 4430 and shell 4440 (shown in FIG. 44.) Side rails 4436 can help to guide and properly position flexible circuit board plug 4600 in connector 4400. Contacts or pads (not shown) on an underside of flexible circuit board 4610 can make electrical contact with top contacting portions 4424 of contacts 4420 in connector 4400 (all shown in FIG. 44.)

Flexible circuit board 4610 can be a multilayer flexible circuit board having two, three, four, or more than four layers. Flexible circuit board 4610 can be formed of Kapton or other material. Cowling or stiffener 4630 can be formed of stainless steel, plastic, or other material. Adhesive 4620 can be a heat activated, pressure sensitive, or other type of adhesive.

Various types of contacts can be used in connector 4400. Examples are shown in the following figures.

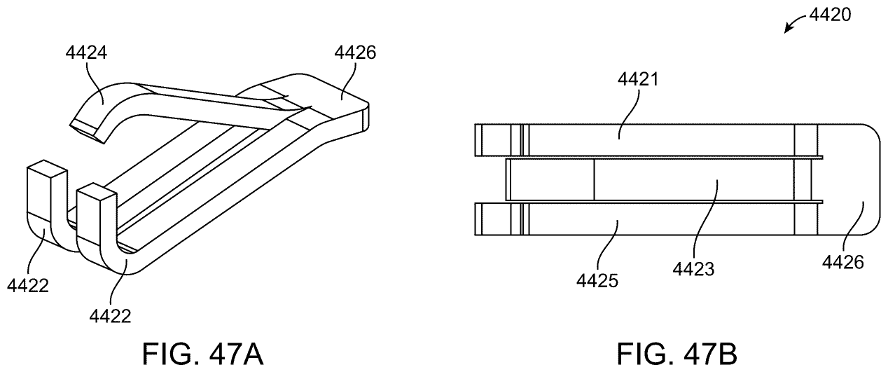

FIG. 47A and FIG. 47B illustrate a contact that can be used in a connector according to an embodiment of the present invention. Specifically, FIG. 47A and FIG. 47B illustrate a contact 4420 that is shown as being used in connector 4400 in FIG. 44. Contact 4420 can include bottom contacting portions 4422 and top contacting portion 4424. Bottom contacting portions 4422 can be on prong 4421 and prong 4425, while top contacting portion 4424 can be on prong 4423. Prong 4421, prong 4423, and prong 4425 can terminate in end 4426. Contact 420 can be stamped to form an outline, then sheared to separate prong 4421, prong 4423, and prong 4425, which can then be stamped to form contact 4420. By including one top contacting portion 4424 between two bottom contacting portions 4422, rocking or tilting among contacts 4420 can be reduced. Contact 4420 can be compliant or flexible and can be under compression during use to ensure a good connection between a printed circuit board and a flexible circuit board plug.

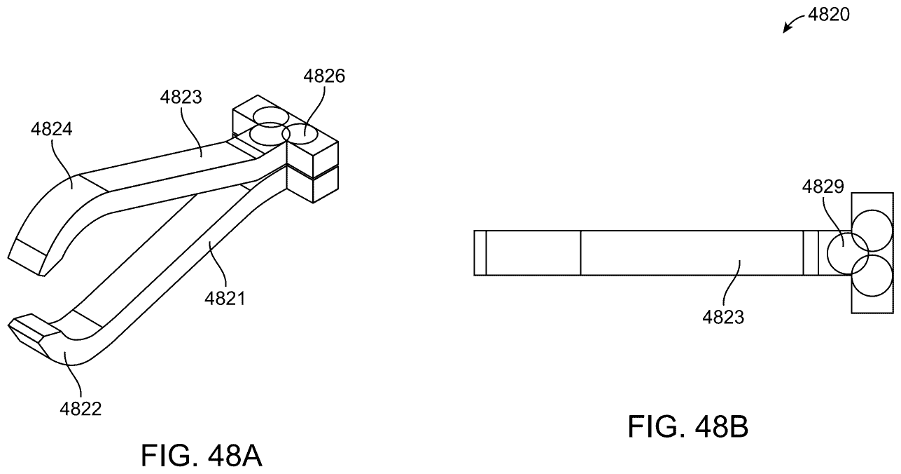

FIG. 48A and FIG. 48B illustrate a contact that can be used in a connector according to an embodiment of the present invention. Contact 4820 can be used in place of contact 4420 in FIG. 44 and in other embodiments of the present invention. Contact 4820 can include bottom contacting portion 4822, top contacting portion 4824, and end 4826. Bottom contacting portion 4822 can be on prong 4821 while top contacting portion 4824 can be on prong 4823. Prong 4821 and prong 4823 can be laser welded at locations 4829 at end 4826. Contact 4820 can be compliant or flexible and can be under compression during use to ensure a good connection between a printed circuit board and a flexible circuit board plug.

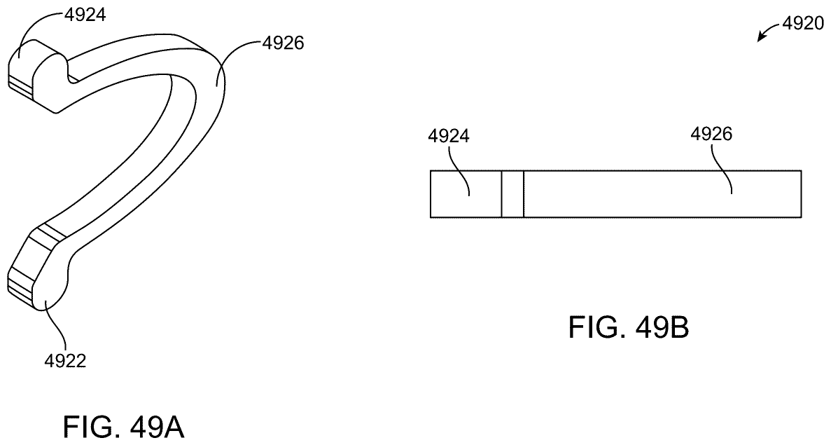

FIG. 49A and FIG. 49B illustrate a contact that can be used in a connector according to an embodiment of the present invention. Contact 4920 can be used in place of contact 4420 in FIG. 44 and in other embodiments of the present invention. Contact 4920 can be stamped of a single piece. Contact 4920 can include bottom contacting portion 4922, top contacting portion 4924, and loop 4926. Contact 4920 can be compliant or flexible and can be under compression during use to ensure a good connection between a printed circuit board and a flexible circuit board plug.

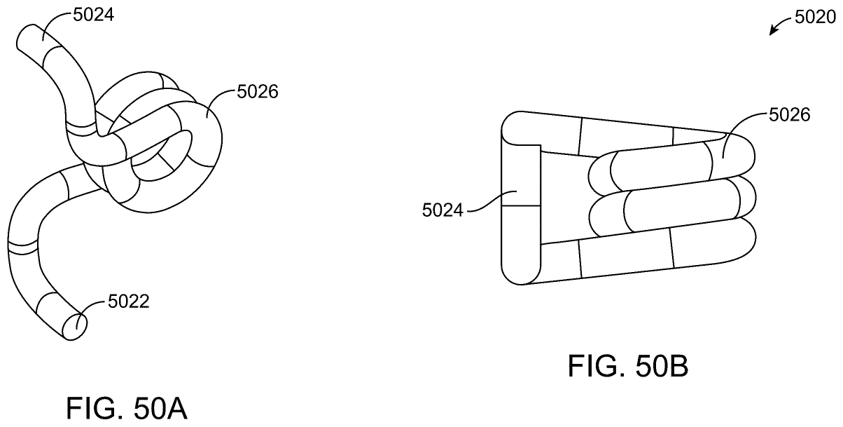

FIG. 50A and FIG. 50B illustrate a contact that can be used in a connector according to an embodiment of the present invention. Contact 5020 can be used in place of contact 4420 in FIG. 44 and in other embodiments of the present invention. Contact 5020 can include bottom contacting portion 5022, top contacting portion 5024, and looped portion 5026. Contact 5020 can be compliant or flexible and can be under compression during use to ensure a good connection between a printed circuit board and a flexible circuit board plug.

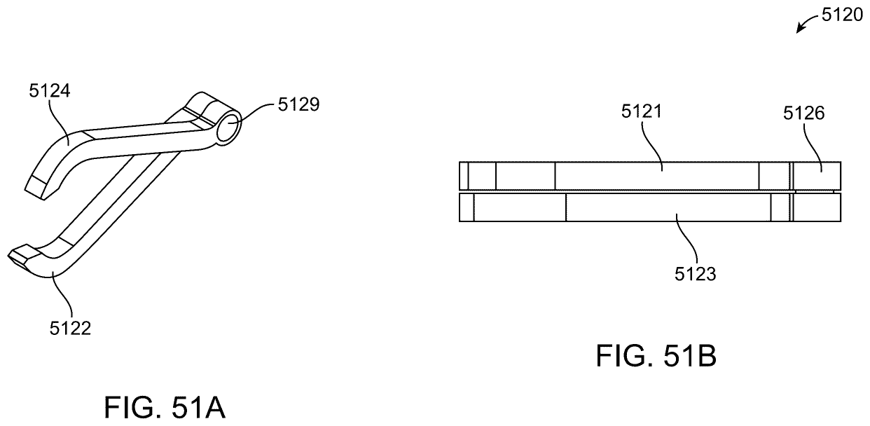

FIG. 51A and FIG. 51B illustrate a contact that can be used in a connector according to an embodiment of the present invention. Contact 5120 can be used in place of contact 4420 in FIG. 44 and in other embodiments of the present invention. Contact 5120 can include bottom contacting portion 5122, top contacting portion 5124, and end 5126. Prong 5121 and prong 5123 can be laser welded together at locations 5129 at end 5126. Contact 5120 can be compliant or flexible and can be under compression during use to ensure a good connection between a printed circuit board and a flexible circuit board plug.

Contacts 4420, contacts 4820, contacts 4920, contacts 5020, and contacts 5120 can be formed of stainless steel, copper, copper alloy, such as a titanium copper alloy, copper zinc alloy, copper tin alloy, copper nickel alloy, or other alloy or other conductive material. These contacts can be at least partially plated with gold or other material. These contacts can be formed by stamping, metal-injection molding, stamping, deep drawing, forging, 3-D printing, or other process. These contacts can be compliant or flexible and can be under compression during use to ensure a good connection between a printed circuit board and a flexible circuit board plug.

The structures in these and other embodiments of the present invention can be formed of various materials. For example, array crossbar 700, array crossbar 2000, array crossbar 2610, array crossbar 3000 and other portions of frame 120, frame 1320, and frame 2720, frame 3200, bottom frame 4410, top frame 4430, and other frames according to embodiments of the present invention can be formed of Liquid Crystal Polymer (LCP), such as SumikaSuper™ E6808, manufactured by Sumitomo Chemical Advanced Technologies of Phoenix, AZ, Laperos® HA475, manufactured by Polyplastics Co. of Tokyo, Japan, or Vectra® S475, manufactured by Celanese Corp. of Irving, TX. These portions can also be formed of plastic, nylon, or other nonconductive material. Contacts 300, contacts 1600, contacts 2600, and contacts 4420 can be formed of copper, copper alloy, stainless steel, or other conductive material. Stiffener 210, stiffener 1410, and cowling or stiffener 4630 can be formed of copper, copper alloy, stainless steel, or other conductive or nonconductive material. Shell 110, shell 1310, and shell 4440 can be formed of copper, copper alloy, stainless steel, or other conductive or nonconductive material. These various structures can be formed using injection molding, stamping, 3-D printing, forging, drawing, or other manufacturing technique.

Embodiments of the present invention can provide connector systems and connectors that can be located in various types of devices, such as portable computing devices, tablet computers, desktop computers, laptops, all-in-one computers, wearable computing devices, cell phones, smart phones, media phones, storage devices, keyboards, covers, charging cases, portable media players, navigation systems, monitors, power supplies, adapters, audio devices and equipment, remote control devices, chargers, and other devices.

These connector systems and connectors can provide pathways for signals and power compliant with various standards such as one of the Universal Serial Bus (USB) standards including USB Type-C, High-Definition Multimedia Interface® (HDMI), Digital Visual Interface (DVI), Ethernet, DisplayPort, Thunderbolt™, Lightning™, Joint Test Action Group (JTAG), test-access-port (TAP), Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. In one example, the connector systems and connectors can be used to convey a data signal, a power supply, and ground. In various embodiments of the present invention, the data signal can be unidirectional or bidirectional and the power supply can be unidirectional or bidirectional. In these and other embodiments of the present invention, the connector systems and connectors can be used to convey power and ground, while data is transmitted wirelessly.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A connector comprising:
a bottom frame having a plurality of openings;
a top frame attached to the bottom frame and having a plurality of openings; and
a plurality of contacts, each having a top contacting portion exposed at a corresponding opening in the bottom frame and a bottom contacting portion exposed at a corresponding opening in the top frame, wherein an end of each contact is secured between the top frame and the bottom frame.

2. The connector of claim 1 further comprising a shell over the top frame.

3. The connector of claim 2 wherein the shell comprises a bent tab that fits in a notch in a side of the bottom frame.

4. The connector of claim 3 wherein the end of each contact is between a top ledge in the top frame and a bottom ledge in the bottom frame, wherein the top ledge is adjacent to an opening in the top frame and the bottom ledge is adjacent to an opening in the bottom frame.

5. The connector of claim 3 wherein the top frame comprises a first side rail on a first side and a second side rail on a second side, wherein the first side rail and second side rail guide and help position a flexible circuit board plug when the flexible circuit board plug is inserted into the connector.

6. The connector of claim 5 wherein each contact comprises a second prong between a first prong and a third prong, wherein the second prong comprises a first contacting portion and the first prong and the second prong each comprise a second contacting portion.

7. The connector of claim 6 wherein the first contacting portion is a top contacting portion the second contacting portions each comprise a bottom contacting portion.

8. A connector system comprising:
a connector comprising:
a top frame having a plurality of openings, a first side rail on a first side of a top of the top frame and a second side rail on a second side of a top of the top frame; and
a plurality of contacts each having a top contacting portion exposed in a corresponding opening of the top frame; and
a shell over the top frame; and
a flexible circuit board plug comprising:
a flexible circuit board having a plurality of contacts on a bottom side; and
a stiffener on a top side of the flexible circuit board,
wherein when the flexible circuit board plug is inserted into the connector, each of the top contacting portions for the plurality of contacts forms an electrical connection with a contact in the plurality of contacts on the bottom side of the flexible circuit board.

9. The connector of claim 8 wherein the flexible circuit board plug is inserted between the top frame, the first side rail on the first side of a top of the top frame, the second side rail on the second side of the top of the top frame, and a bottom side of the shell.

10. The connector of claim 9 further comprising a bottom frame attached to a bottom of the top frame.

11. The connector of claim 10 wherein an end of each contact is secured between the top frame and the bottom frame.

12. The connector of claim 11 wherein the end of each contact is between a top ledge in the top frame and a bottom ledge in the bottom frame, wherein the top ledge is adjacent to an opening in the top frame and the bottom ledge is adjacent to an opening in the bottom frame.

13. The connector of claim 12 wherein the shell comprises a bent tab that fits in a notch in a side of the bottom frame.

14. The connector of claim 13 wherein the stiffener is attached to the flexible circuit board using an adhesive.

15. A connector system comprising:
a flexible circuit board having an end, a cowling over the end, and a latch formed in the cowling; and
a connector comprising:
an array of contacts;
a frame supporting the array of contacts; and
a shell over the frame and the array of contacts, wherein the shell comprises a plurality of openings to accept the latch formed in the cowling on the flexible circuit board, wherein the openings are arranged along a length of the latch when the flexible circuit board is inserted in the connector, wherein the openings are separated by a shell crossbar.

16. The connector system of claim 15 wherein the cowling comprises a plurality of latches.

17. The connector system of claim 15 wherein the shell crossbar prevents the latch from extending above a top surface of the shell.

18. The connector system of claim 17 wherein the latch is stamped in the cowling.

19. The connector system of claim 18 wherein the array of contacts comprises a plurality of rows, wherein each row comprises a plurality of contacts and an array crossbar joining the plurality of contacts.

20. The connector system of claim 19 wherein the shell comprises a plurality of tabs folded under the frame and located in corresponding recesses in a bottom of the frame.
